(19) United States
(12) Patent Application Publication
(10) Pub. No.: US 2005/0010763 A1
(43) Pub. Date: Jan. 13, 2005

(54) Data transceiver and data transceiver system

(75) Inventors: Takayuki Matsui, Osaka (JP); Ryogo Yanagisawa, Osaka (JP)

Correspondence Address: Jack Q. Lever, Jr.;McDERMOTT, WILL & EMERY, 600 Thirteenth Street, N.W., Washington, DC, 20005-3096, US

(73) Assignee: MATSUSHITA ELECTRIC INDUSTRIAL CO., LTD.

(21) Appl. No.: 10/858,298

(22) Filed: Jun. 2, 2004

(30) Foreign Application Priority Data
Jun. 11, 2003 (JP) 2003-165997

(51) Int. Cl. H04L 9/00

(52) U.S. Cl. 713/165

(57) ABSTRACT

A data transceiver includes: at least first and second encrypting/decrypting means each for encrypting and decrypting data; and transceiver means for transmitting and receiving data. In a first transmission mode, first transmission data encrypted by the first or second encrypting/decrypting means is transmitted by the transceiver means. In a first reception mode, first received data received by the transceiver means is decrypted by the first or second encrypting/decrypting means. In a second transmission mode, second transmission data decrypted by the first encrypting/decrypting means is encrypted by the second encrypting/decrypting means and then is transmitted by the transceiver means. In a second reception mode, second received data received by the transceiver means is decrypted by the second encrypting/decrypting means and then is encrypted by the first encrypting/decrypting means.

### BACKGROUND OF THE INVENTION

The present invention relates to techniques for encrypting content data on networks to prevent illegal copying.

In the recent digital society, digital AV data needs to be transferred by connecting home AV appliances together. As a technique for implementing such a digital AV data transfer, the IEEE 1394 standard has been widely used. The digital AV data thus used has excellent features. For example, the data can be compressed by various compression methods and does not deteriorate even after repetitive replays. However, the digital AV data has the drawback of “easiness of illegal copying of its contents”. Therefore, it has been required to establish a technique for “protection against illegal copying”. With respect to digital AV data which is transferred in compliance with the IEEE 1394 standard, “protections against illegal copying” have been achieved with a DTCP (Digital Transmission Content Protection) technique.

The reasons why the IEEE 1394 standard has been widely used for home AV appliances are that the IEEE 1394 standard enables a high-speed transfer of digital AV data (400 Mbps at the maximum) and that techniques for protection against illegal copying have been established as described above.

Hereinafter, a known IEEE 1394 LSI conforming to the IEEE 1394 standard for which the illegal copying protection techniques have been established will be described with reference to the drawings.

FIG. 27 is a diagram showing a configuration of an IEEE 1394 LSI (production No. MN864602) produced by Matsushita Electric Industrial Co., Ltd. as an example of IEEE 1394 LSIs that are widely used in AV appliances at present.

As shown in FIG. 27, the IEEE 1394 LSI (hereinafter, referred to as a 1394 LSI) 10 includes: a PHY (physical layer) 11; a LINK Control (link layer) 12; an ISO (isochronous processing block) 13; an Async (asynchronous processing block) 14; Authentication (AKE accelerator) 15; and an I/O Control (external interface) & PID (Packet Identification) Filter 16. The physical layer 11 initializes an IEEE 1394 bus (hereinafter, referred to as a 1394 bus) connected to a repeater or an IEEE 1394 terminal (hereinafter, referred to as a 1394 terminal). The link layer 12 exchanges data with the physical layer 11. The isochronous processing blocks 13 perform protocol processing for an isochronous transfer of data. The asynchronous processing block 14 performs protocol processing for an asynchronous transfer of data. To protect copyrights in 1394 packets to be transmitted/received through 1394 buses 18, the AKE (Authentication and Key Exchange) accelerator 15 generates a key for encrypting and decrypting the 1394 packets in compliance with the DTCP standard. The external interface (16) inputs and outputs data through external buses 20 connected to external interface port terminals 19.

FIG. 28 is a diagram showing a configuration of a 1394 packet transmitted or received through the 1394 buses 18 shown in FIG. 27.

As shown in FIG. 28, a 1394 packet 50 is constituted by: a 1394 packet header 51; a CIP (Common Isochronous Packet) header 52; content data 53 (e.g., MPEG data); and data_CRC 54.

Hereinafter, the flow of, for example, MPEG data (content data 53) constituting the 1394 packet 50 received through one of the 1394 buses 18 until the MPEG data is output from the 1394 LSI 10 will be described with reference to FIGS. 27 and 28.

First, as shown in FIG. 27, the 1394 packet 50 received through one of the 1394 buses 18 connected to 1394 terminals 17 is transferred to the link layer 12 by way of the physical layer 11. The data type of the 1394 packet 50 transmitted to the link layer 12 is determined in the link layer 12 based on the 1394 packet header 51 constituting the 1394 packet 50. In the link layer 12, the 1394 packet header 51 and the data_CRC 54 are removed from the 1394 packet 50 whose data type has been determined. Then, the resultant 1394 packet 50 is sent to the isochronous processing blocks 13. Thereafter, in the isochronous processing blocks 13, the protocol is determined based on the CIP header 52 constituting the 1394 packet 50. Subsequently, the CIP header 52 is also removed. Lastly, the MPEG data (53) remaining in the 1394 packet 50 passes through the external interface (16) and then is output through the external buses 20 connected to the external interface port terminals 19.

As shown in FIG. 27, the 1394 terminals 17 connected to the 1394 buses 18 are constituted by two terminals, i.e., a first 1394 terminal 17a and a second 1394 terminal 17b. The isochronous processing blocks 13 are constituted by two blocks capable of processing content data independently of each other, i.e., a first isochronous processing block 13a and a second isochronous processing block 13b. The external interface port terminals 19 connected to the external buses 20 are constituted by two terminals, i.e., a first external interface port terminal 19a and a second interface port terminal 19b. The physical layer 11 includes two independent ports, i.e., a first port 21a and a second port 21b.

With this configuration, two types of content data 53 are processed independently of each other using the first and second isochronous processing blocks 13a and 13b, respectively. Accordingly, if a DVD recorder, for example, is connected to the first and second 1394 terminals 17a and 17b of the 1394 LSI 10, recording of an MPEG image input to the external interface port terminals 19 and playback and display of the MPEG image recorded in the DVD recorder on a display screen, for example, connected to the external buses 20 are performed at the same time with the single DVD recorder.

Each of the isochronous processing blocks 13 (e.g., the first isochronous processing block 13a) has the function of encrypting MPEG data input through the external buses 20 as well as the function of decrypting MPEG data received through the 1394 buses 18. Specifically, in data transmission, MPEG data which has been input through one of the external buses 20 connected to the first external interface port terminal 19a is encrypted in the first isochronous processing block 13a using an encryption key generated by the AKE accelerator 15. In data reception, MPEG data which has been encrypted by another node on one of the 1394 buses 18 connected to the first 1394 terminal 17a is decrypted in the isochronous processing block 13a using a decryption key generated by the AKE accelerator 15. In this manner, each of the first and second isochronous processing blocks 13a and 13b serves as an encrypting section (having an encrypting function) as well as a decrypting section (having a decrypting function) in order to cope with both transmission and reception of data. That is, the first and second isochronous processing blocks 13a and 13b are configured to utilize an illegal copying protection technique established in compliance with the IEEE 1394 standard. Accordingly, if MPEG data which needs a copyright protection is output through the 1394 buses 18, the MPEG data can be encrypted before being output, thus enhancing the security of content data to be transmitted/received.

In transmitting data which does not need copyright protection, input data can be transmitted without being encrypted in the isochronous processing block.

In the same manner, in the case of receiving data which does not need copyright protection (data which is not encrypted), the data can be output without being processed.

In recent years, the tendency to wireless communication between PCs (personal computers) has been accelerated. For example, products for establishing wireless communication between devices, e.g., between a PC and a monitor (especially a liquid-crystal display) or between PCs used for constructing a LAN, using the IEEE 802.11b standard (2.4 GHz band/11 Mbps at the maximum) are commercially available. With this tendency, “wireless communication among home AV appliances” has received considerable attention. That is, there has been an increasing demand to wirelessly transmit digital AV data (e.g., digital AV data transferred in compliance with the IEEE 1394 standard) for home digital AV appliances.

Hereinafter, an example of the aforementioned configuration will be described with reference to FIG. 29, and the flow of data in wireless transmission of digital AV data will be also described using MPEG data as an example.

FIG. 29 is a block diagram schematically showing a configuration in which the IEEE 1394 LSI 10 shown in FIG. 27 and a wireless module are combined for wireless transmission.

As shown in FIG. 29, a 1394 device (D-VHS) 22 capable of playing back and recording an MPEG image and the 1394 LSI 10 are connected to each other via the 1394 buses 18. A wireless module 24 including an encrypting section 23 and the 1394 LSI 10 are connected to each other via the external buses 20.

In a case where MPEG data stored in the 1394 device 22 is transmitted from the wireless module 24 in a wireless manner, the MPEG data transmitted from the 1394 device 22 through the 1394 buses 18 is decrypted in the 1394 LSI 10 first. Then, the decrypted MPEG data is output from the 1394 LSI 10 to the wireless module 24 through the external buses 20. The MPEG data input to the wireless module 24 is reencrypted in the encrypting section 23 in the wireless module 24. This encrypted MPEG data is transmitted from the wireless module 24 in a wireless manner. The encrypting section 23 may be provided outside the wireless module 24.

Hereinafter, the aforementioned flow of the MPEG data will be described specifically using the 1394 LSI 10 with reference to FIG. 30.

FIG. 30 is a block diagram showing a specific configuration of the wireless communication that is schematically shown in FIG. 29.

As shown in FIG. 30, first, (encrypted) MPEG data transmitted from the 1394 device 22 is received by the 1394 LSI 10 through one of the 1394 buses 18 connected to the associated 1394 terminal 17. Then, the MPEG data which has passed through the physical layer 11 and the link layer 12 is decrypted in one of the isochronous processing blocks 13 using a decryption key generated by the AKE accelerator 15. Thereafter, the decrypted MPEG data is output to the wireless module 24 through one of the external buses 20. The MPEG data which has been input to the wireless module 24 through one of the external buses 20 is reencrypted in the encrypting section 23 constituting the wireless module 24. Then, this reencrypted MPEG data is transmitted from the wireless module 24 in a wireless manner.

In this manner, in wireless communication using the known 1394 LSI 10, digital AV data to be output from the 1394 LSI 10 to the wireless module 24 has been decrypted in the 1394 LSI 10. Accordingly, if a probe is used to the external buses 20 connecting the 1394 LSI 10 and the wireless module 24, for example, digital AV data which is being transferred through the external buses 20 might be illegally copied or intercepted by a third party easily.

As an example to eliminate this possibility, a device having two encryption circuits, to be more specific, a repeater having an encrypted data decrypting section for decrypting encrypted data and an encrypting section for further encrypting the decrypted data was proposed (see, for example, Japanese Laid-Open Publication No. 2000-174797). With this device, encrypted data received by the repeater through a 1394 bus is decrypted by the encrypted data decrypting section constituting the repeater, and then is reencrypted by the encrypting section to be output. Accordingly, illegal copying or intercepting is prevented.

However, in the known technique (MN864602) as shown in FIG. 27, each of the isochronous processing blocks 13 (13a or 13b) serving as one block has both functions of encryption and decryption. Accordingly, if the repeater disclosed in the above-mentioned publication is applied to the known 1394 LSI 10 without change, two encryption circuits associated with transmission and reception, respectively, need to be added to each of the isochronous processing blocks 13 (13a and 13b). As a result, suppose the 1394 LSI 10 is configured to be capable of processing two digital AV data sets independently of each other, a total of four encryption circuits need to be added to the 1394 LSI 10. This increases the circuit scale. Thus, protection against illegal copying by adding encryption circuits is not practical.

### SUMMARY OF THE INVENTION

It is therefore an object of the present invention to provide a 1394 LSI capable of protecting copyright of digital AV content data on a 1394 bus even when the LSI is connected to a wireless communication system, without increasing the circuit scale.

A first data transceiver of the present invention includes: at least first and second encrypting/decrypting means each for encrypting and decrypting data; and transceiver means for transmitting and receiving data, wherein first transmission data encrypted by the first or second encrypting/decrypting means is transmitted by the transceiver means in a first transmission mode, first received data received by the transceiver means is decrypted by the first or second encrypting/decrypting means in a first reception mode, second transmission data decrypted by the first encrypting/decrypting means is encrypted by the second encrypting/decrypting means and then is transmitted by the transceiver means, in a second transmission mode, and second received data received by the transceiver means is decrypted by the second encrypting/decrypting means and then is encrypted by the first encrypting/decrypting means, in a second reception mode.

The first data transceiver includes the transceiver means for transmitting and receiving data and a plurality of encrypting/decrypting means for encrypting and decrypting data. Accordingly, if unencrypted data is input, for example, transmission in the first transmission mode is performed, thereby encrypting the input data (first transmission data) before transmitting the data. If data which does not need copyright protection is received, for example, reception in the first reception mode is performed, thereby decrypting the received data (first received data) before outputting the data. In this manner, it is possible to perform transmission and reception of data suitable for a case where data which does not need copyright protection, non-confidential data or the like is input or output to/from an external device.

In the first data transceiver, if encrypted data is input, for example, transmission in the second transmission mode is performed, thereby decrypting then reencrypting the input data (second transmission data) before transmitting the data. If data which needs copyright protection is received, for example, reception in the second reception mode is performed, thereby decrypting and then reencrypting the received data (second received data) before outputting the data. Accordingly, even in the case of inputting or outputting data to/from an external device, it is possible to prevent the data to be input or output to/from the external device from being illegally copied or intercepted by a third party. In other words, copyright of data input or output to/from the external device is protected. This ensures robustness of copyright protection of data on a network connected to the data transceiver of the present invention.

In the first data transceiver, data reencryption necessary for protection against illegal copying or intercepting is performed by switching the data transmission path. This eliminates the necessity of adding a new encryption circuit for reencrypting data. That is, it is possible to protect copyright without increasing the circuit scale. In addition, the unnecessity of adding a new encryption circuit also eliminates the necessity of designing a new transceiver circuit. More specifically, it is unnecessary to design a new transceiver circuit exclusively for reencrypting transmission data or received data. As a result, the period required to design a circuit is shortened and the design cost is reduced.

In the second transmission mode of the first data transceiver, it is preferable that the second transmission data is decrypted by the first encrypting/decrypting means using a first key and then is encrypted by the second encrypting/decrypting means using a second key.

Then, in the second transmission mode, the encrypted second transmission data is decrypted using the first key and then is reencrypted using the second key which is different from an encryption key used for encrypting the second transmission data. This ensures robustness of copyright protection of data on a network connected to the data transceiver of the present invention.

In the second reception mode of the first data transceiver, it is preferable that the second received data is decrypted by the second encrypting/decrypting means using a third key and then is encrypted by the first encrypting/decrypting means using a fourth key.

Then, in the second reception mode, the encrypted second received data is decrypted using the third key and then reencrypted using the fourth key which is different from an encryption key used for encrypting the second received data. This ensures robustness of copyright protection of data on a network connected to the data transceiver of the present invention.

The first data transceiver preferably further includes switching means for switching between a data transmission path for use in the first transmission mode and a data transmission path for use in the second transmission mode or between a data transmission path for use in the first reception mode and a data transmission path for use in the second reception mode.

Then, switching between the data transmission path for use in the first transmission mode in which unencrypted first transmission data is encrypted and then transmitted and the data transmission path for use in the second transmission mode in which encrypted second transmission data is reencrypted and then transmitted is performed. In addition, switching between the data transmission path for use in the first reception mode in which encrypted first received data is decrypted and then output and the data transmission path in the second reception mode in which encrypted second received data is reencrypted and then output is also performed. Accordingly, data to be transmitted or received is protected in a manner depending on, for example, the level of the necessity of copyright protection or confidentiality of the data.

If the switching means for switching between the data transmission paths is provided, the switching means preferably includes: a first selector provided on a data transmission path between the first encrypting/decrypting means and the transceiver means; and a second selector provided on a data transmission path for data which has passed through a data transmission path between the second encrypting/decrypting means and the transceiver means to be output from the second encrypting/decrypting means. In this case, a data transmission path along which the second transmission data passes through the first encrypting/decrypting means, the first selector, the second selector, the second encrypting/decrypting means and the transceiver means in this order is preferably selected in the second transmission mode, and a data transmission path along which the second received data passes through the transceiver means, the second encrypting/decrypting means, the second selector, the first selector and the first encrypting/decrypting means in this order is preferably selected in the second reception mode.

Then, the data transmission paths are selected by the first and second selectors, thereby allowing switching between the data transmission paths in the first transmission mode and the first reception mode and the data transmission paths in the second transmission mode and the second reception mode. Accordingly, data to be transmitted or received is protected in a manner depending on, for example, the level of the necessity of copyright protection or confidentiality of the data.

If the switching means for switching between the data transmission paths is provided, the switching means preferably includes: a first switch provided on a data transmission path between the first encrypting/decrypting means and the transceiver means; a second switch provided on a data transmission path for data which has passed through a data transmission path between the second encrypting/decrypting means and the transceiver means to be output from the second encrypting/decrypting means; and a third switch provided on a data transmission path connecting the data transmission path between the first encrypting/decrypting means and the first switch and the data transmission path between the second encrypting/decrypting means and the second switch to each other. In this case, the first through third switches are preferably turned ON or OFF in combination in such a manner that a data transmission path along which the second transmission data passes through the first encrypting/decrypting means, the third switch, the second encrypting/decrypting means and the transceiver means in this order is selected in the second transmission mode and a data transmission path along which the second received data passes through the transceiver means, the second encrypting/decrypting means, the third switch and the first encrypting/decrypting means in this order is selected in the second reception mode.

Then, the combination of the first through third switches in the ON or OFF states allows switching between the data transmission paths in the first transmission mode and the first reception mode and the data transmission paths in the second transmission mode and the second reception mode. This ensures protection of data to be transmitted or received performed in a manner depending on, for example, the level of the necessity of copyright protection or confidentiality of the data. In addition, if the first and second switches are turned ON and the third switch is turned OFF, transmissions in the first and second transmission modes, for example, are performed at the same time.

A second data transceiver of the present invention includes: at least first and second encrypting/decrypting means each for encrypting and decrypting data; and transceiver means for transmitting and receiving data, wherein first transmission data encrypted by the first or second encrypting/decrypting means is transmitted by the transceiver means in a first transmission mode, first received data received by the transceiver means is decrypted by the first or second encrypting/decrypting means in a first reception mode, and second transmission data received by the transceiver means is decrypted by the first encrypting/decrypting means, is encrypted by the second encrypting/decrypting means and then is transmitted by the transceiver means, in a second transmission mode.

In the second data transceiver, if encrypted data is received, transmission in the second transmission mode is performed, thereby decrypting and then reencrypting the received data (second transmission data) before transmitting the data. Accordingly, even in the case of data stored in an external device which does not have the function of reencryption, for example, the data is reencrypted by passing through the second data transceiver in the second transmission mode. That is, the second data transceiver serves as a reencrypting device. This ensures robustness of copyright protection of data on a network connected to the external device.

In the case of transmission in the second transmission mode of the second data transceiver, it is preferable that the second transmission data is decrypted by the first encrypting/decrypting means using a fifth key and then is encrypted by the second encrypting/decrypting means using a sixth key.

Then, in the second transmission mode, encrypted second transmission data is decrypted using the fifth key and then reencrypted using the sixth key which is different from an encryption key used for encrypting the second transmission data. This ensures the aforementioned advantages.

In the case of transmission in the second transmission mode of the second data transceiver, the second data transceiver preferably further includes: a first selector provided on a data transmission path for data which has passed through a data transmission path between the first encrypting/decrypting means and the transceiver means to be output from the first encrypting/decrypting means; and a second selector provided on a data transmission path for data which has passed through the data transmission path between the first encrypting/decrypting means and the transceiver means to be output from the second encrypting/decrypting means. In this case, in the second transmission mode, a data transmission path along which the second transmission data passes through the transceiver means, the first encrypting/decrypting means, the first selector, the second selector, the second encrypting/decrypting means and the transceiver means in this order is preferably selected.

Then, the first and second selectors allows switching between the data transmission paths, thereby performing switching between the data transmission paths in the first transmission mode and the first reception mode and the data transmission paths in the second transmission mode and the second reception mode. This ensures the aforementioned advantages.

The first or second data transceiver preferably further includes a key setting controlling section for selecting the type of a key for use in encryption or decryption performed by each of the first and second encrypting/decrypting means and for determining whether or not the key is set in each of the first and second encrypting/decrypting means.

Then, the key setting controlling section selects the types of keys for encrypting or decrypting data, so that copyright of data is appropriately protected in a manner depending on, for example, the importance of data to be transmitted or received or an encryption or decryption method of an external device to which the data is to be transmitted or output. This ensures robustness of copyright protection of data on a network connected to the first or second data transceiver. In addition, the key setting controlling section determines whether to set a key for encrypting or decrypting data, so that the data transceiver of the present invention is also applicable to the case of processing data which needs neither encryption nor decryption.

If the selectors are provided, the first or second data transceiver preferably further includes a selector controlling section for determining the selections of the data transmission paths performed by the first and second selectors.

Then, the selector controlling section determines switching between data transmission paths performed by the first and second selectors. Accordingly, in the first data transceiver, switching between the data transmission paths in the first transmission mode and the first reception mode and the data transmission paths in the second transmission mode and the second reception mode is performed arbitrarily as intended. In the same manner, in the second data transceiver, switching between the data transmission paths in the first transmission mode and the first reception mode and the data transmission paths in the second transmission mode and the second reception mode is also performed arbitrarily as intended.

If the selector controlling section is provided, the selector controlling section preferably includes a register in which information for determining operation of the first and second selectors is written.

Then, an instruction for switching between the data transmission paths is written in a register associated with one of the first and second selectors, for example, thus ensuring control of switching between data transmission paths. The switching between data transmission paths is controlled in the inside of the first or second data transceiver.

If the switches are provided, the first data transceiver preferably further includes a switch controlling section for determining the switching between the data transmission paths performed by each of the first through third switches.

Then, the switch controlling section determines switching between data transmission paths performed by the first through third switches, so that switching between the data transmission paths in the first transmission mode and the first reception mode and the data transmission paths in the second transmission mode and the second reception mode is also performed arbitrarily as intended.

If the switch controlling section is provided, the switch controlling section preferably includes a register in which information for determining operation of the first through third switches is written.

Then, an instruction for switching between the data transmission paths is written in a register associated with one of the first through third switches, for example, thus ensuring control of switching between data transmission paths. The switching between data transmission paths is controlled in the inside of the first data transceiver.

In the first or second data transceiver, the transceiver means preferably includes at least first and second transceiver means, and transmission of the first transmission data by the first transceiver means in the first transmission mode and reception of the first received data by the second transceiver means in the first reception mode are preferably performed at the same time.

Then, since the transceiver means is composed of a plurality of transceiver means, transmission of the first transmission data encrypted in the first transmission mode and output of the first received data decrypted in the first reception mode are performed independently of each other at the same time.

A third data transceiver of the present invention includes: at least first and second encrypting/decrypting means each for encrypting and decrypting data; transceiver means for transmitting and receiving data; an input/output interface for input and output of data to/from an external device; first switching means provided on a data transmission path between the transceiver means and the first encrypting/decrypting means; and second switching means provided on a data transmission path between the input/output interface and the second encrypting/decrypting means, wherein the first switching means operates in such a manner as to connect the data transmission path between the first switching means and the first encrypting/decrypting means to a data transmission path between the first switching means and the transceiver means or to a data transmission path between the first switching means and the second switching means, and the second switching means operates in such a manner as to connect the data transmission path between the second switching means and the second encrypting/decrypting means to the data transmission path between the second switching means and the input/output interface or to the data transmission path between the second switching means and the first switching means.

The third data transceiver includes the first switching means for switching between the data transmission paths. Accordingly, the data transmission path between the first switching means and the first encrypting/decrypting means is allowed to be connected to one or both of the data transmission path between the first switching means and the transceiver means and the data transmission path between the first switching means and the second switching means by operating the first switching means. In the same manner, since the third data transceiver includes the second switching means for switching between the data transmission paths, the data transmission path between the second switching means and the second encrypting/decrypting means is allowed to be connected to one or both of the data transmission path between the second switching means and the input/output interface and the data transmission path between the second switching means and the first switching means by operating the second switching means. In this manner, unencrypted data input to the input/output interface, for example, is encrypted by the first encrypting/decrypting means, passes through the first switching means and then is transmitted by the transceiver means. In addition, encrypted data received by the transceiver means is decrypted by the second encrypting/decrypting means, passes through the second switching means and then is output from the input/output interface. As a result, data transmission and reception suitable for the case of inputting and outputting data which does not need copyright protection, non-confidential data or the like to/from an external device is performed.

In the third data transceiver, encrypted data input to the input/output interface is decrypted by the first encrypting/decrypting means, passes through the first switching means and the second switching means in this order, is reencrypted by the second encrypting/decrypting means and then is transmitted by the transceiver means. In addition, encrypted data received by the transceiver means is decrypted by the second encrypting/decrypting means, passes through the second switching means and the first switching means in this order, is reencrypted by the first encrypting/decrypting means and then is output from the input/output interface. Accordingly, even if data is input or output to/from an external device, it is possible to prevent the data from being illegally copied or intercepted by a third party. In other words, copyright of the data input or output to/from the external device is protected. This ensures robustness of copyright protection of data on a network connected to the third data transceiver of the present invention.

In the third data transceiver, the process of decrypting encrypted data received by the transceiver means by the second encrypting/decrypting means and then outputting the data from the input/output interface and the process of decrypting the encrypted data by the second encrypting/decrypting means, reencrypting the data by the first encrypting/decrypting means and then outputting the data from the input/output interface are performed at the same time.

A fourth data transceiver of the present invention includes: at least first and second encrypting/decrypting means each for encrypting and decrypting data; transceiver means for transmitting and receiving data; an input/output interface for input and output of data to/from an external device; first switching means provided on a data transmission path between the input/output interface and the first encrypting/decrypting means; and second switching means provided on a data transmission path between the input/output interface and the second encrypting/decrypting means, wherein the first switching means operates in such a manner as to connect the data transmission path between the first switching means and the first encrypting/decrypting means to the data transmission path between the first switching means and the input/output interface or to a data transmission path between the first switching means and the second switching means, and the second switching means operates in such a manner as to connect the transmission path between the second switching means and the second encrypting/decrypting means to the data transmission path between the second switching means and the input/output interface or to the data transmission path between the second switching means and the first switching means.

The fourth data transceiver includes the first switching means for switching between the data transmission paths. Accordingly, the data transmission path between the first switching means and the first encrypting/decrypting means is allowed to be connected to one or both of the data transmission path between the first switching means and the input/output interface and the data transmission path between the first switching means and the second switching means by operating the first switching means. In the same manner, since the third data transceiver includes the second switching means for switching between the data transmission paths, the data transmission path between the second switching means and the second encrypting/decrypting means is allowed to be connected to one or both of the data transmission path between the second switching means and the input/output interface and the data transmission path between the second switching means and the input/output interface by operating the second switching means. In this manner, unencrypted data input to the input/output interface, for example, passes through the first switching means, is encrypted by the first encrypting/decrypting means and then is transmitted by the transceiver means. In addition, encrypted data received by the transceiver means is decrypted by the second encrypting/decrypting means, passes through the second switching means and then is output from the input/output interface. As a result, data transmission and reception suitable for the case of inputting and outputting data which does not need copyright protection, non-confidential data or the like to/from an external device is performed.

In the fourth data transceiver, encrypted data received by the transceiver means is decrypted by the first encrypting/decrypting means, passes through the first switching means and the second switching means in this order, is reencrypted by the second encrypting/decrypting means and then is transmitted by the transceiver means. Accordingly, even in the case of data stored in an external device which does not have the function of reencryption, for example, the data is reencrypted by passing through the fourth data transceiver of the present invention. That is, the fourth data transceiver of the present invention serves as a reencrypting device. This ensures robustness of copyright protection of data on a network connected to the external device.

Each of the first through fourth data transceivers is preferably integrated on a single integrated circuit.

Then, the first through fourth data transceivers are integrated on a single integrated circuit to form LSI. Accordingly, in the second reception mode, for example, second received data is neither illegally copied nor intercepted by a third party from when the data is decrypted to when the data is reencrypted.

In each of the first through fourth data transceivers, the transceiver means preferably performs transmission and reception in compliance with the IEEE 1394 standard.

Then, the transceiver means performs transmission and reception in compliance with the IEEE 1394 standard. Accordingly, even in the case of receiving data encrypted based on the IEEE 1394 standard, for example, reception in the second reception mode is performed, thereby outputting reencrypted data (second received data). This prevents illegal copying or intercepting of the second received data after the data has been output. That is to say, copyright of data protected on an IEEE 1394 network is still protected even after the data has been output. Accordingly, even if data is input or output to/from a wireless device, robustness of copyright protection of data on the IEEE 1394 network is ensured.

A data transceiver system of the present invention includes: a first data transceiver including at least first and second encrypting/decrypting means each for encrypting and decrypting data and transceiver means for transmitting and receiving data; and a second data transceiver for transmitting and receiving data, wherein first transmission data received by the second data transceiver is output to the first data transceiver, is decrypted by the first or second encrypting/decrypting means and then is transmitted by the transceiver means, in a first transmission mode, first received data received by the transceiver means is decrypted by the first or second encrypting/decrypting means, is output to the second data transceiver and then is transmitted by the second data transceiver, in a first reception mode, second transmission data received by the second data transceiver is output to the first data transceiver, is decrypted by the first encrypting/decrypting means, is encrypted by the second encrypting/decrypting means and then is transmitted by the transceiver means, in a second transmission mode, and second received data received by the transceiver means is decrypted by the second encrypting/decrypting means, is encrypted by the first encrypting/decrypting means, is output to the second data transceiver, and then is transmitted by the second data transceiver, in a second reception mode.

In the data transceiver system of the present invention, the first data transceiver includes the transceiver means for transmitting and receiving data and a plurality of encrypting/decrypting means for encrypting and decrypting data. Accordingly, if unencrypted data received by the second data transceiver, for example, is input to the first data transceiver, transmission in the first transmission mode is performed, thereby encrypting data (first transmission data) input to the first data transceiver before transmitting the data. If data which does not need copyright protection by the transceiver means of the first data transceiver, for example, is received, reception in the first reception mode is performed, thereby decrypting the received data (first received data) and then outputting the data to the second data transceiver. As a result, the first and second data transceivers exchange data in a manner suitable for the case of inputting or outputting data which does not need copyright protection, non-confidential data or the like.

In the data transceiver system of the present invention, if encrypted data received by the second data transceiver is input to the first data transceiver, for example, transmission in the second transmission mode is performed, thereby reencrypting the input data (second transmission data) before transmitting the data. If data which needs copyright protection is received by the transceiver means of the first data transceiver, for example, reception in the second reception mode is performed, thereby decrypting the received data (second received data) and then outputting the data to the second data transceiver. As a result, in the case of inputting or outputting the data between the first and second data transceivers, illegal copying or intercepting of the data by a third party is prevented. In other words, copyright of data which is input or output between the first and second data transceivers is protected. This ensures robustness of copyright protection of data on a network connected to the first and second data transceivers.

In the data transceiver system of the present invention, the first data transceiver preferably further includes switching means for switching between a data transmission path for use in the first transmission mode and a data transmission path for use in the second transmission mode or between a data transmission path for use in the first reception mode and a data transmission path for use in the second reception mode.

Then, switching between the data transmission path in the first transmission mode in which unencrypted data (first transmission data) is output from the second data transceiver to the first data transceiver and the data transmission path in the second transmission mode in which encrypted data (second transmission data) is input from the second data transceiver to the first data transceiver is performed. In addition, switching between the data transmission path in the first reception mode in which unencrypted data (first received data) is output from the first data transceiver to the second data transceiver and the data transmission path in the second reception mode in which reencrypted data (second received data) is input from the first data transceiver to the second data transceiver is also performed. Accordingly, data which is input or output between the first and second data transceivers is protected in a manner depending on, for example, the level of the necessity of copyright protection or confidentiality of the data.

In the data transceiver system of the present invention, it is preferable that in the second transmission mode, the second transmission data is decrypted by the first encrypting/decrypting means using a seventh key and then is encrypted by the second encrypting/decrypting means using an eighth key.

Then, in the second transmission mode, encrypted second transmission data is decrypted using the seventh key and then is reencrypted using the eighth key which is different from an encryption key used for encrypting the second transmission data. This ensures robustness of copyright protection of data on a network connected to the first and second data transceivers.

The data transceiver system of the present invention, it is preferable that in the second reception mode, the second received data is decrypted by the second encrypting/decrypting means using a ninth key and then is encrypted by the first encrypting/decrypting means using a tenth key.

Then, in the second reception mode, encrypted second received data is decrypted using the ninth key and then is reencrypted using the tenth key which is different from an encryption key used for encrypting the second received data. This ensures robustness of copyright protection of data on a network connected to the first and second data transceivers.

In the data transceiver system of the present invention, the transceiver means of the first data transceiver preferably performs transmission and reception in compliance with the IEEE 1394 standard.

Then, the transceiver means performs transmission and reception in compliance with the IEEE 1394 standard, so that copyright of data protected based on the IEEE 1394 standard is still protected in a communication between the first and second data transceivers. That is, robustness of copyright protection of data on an IEEE 1394 network connected to the first data transceiver is ensured.

In the data transceiver system of the present invention, the second data transceiver preferably performs transmission and reception in compliance with the IEEE 802.11 standard.

Then, the second data transceiver performs transmission and reception in compliance with the IEEE 802.11 standard. Accordingly, even in the case of wireless communication conforming to the IEEE 802.11 standard, copyright of data protected based on the IEEE 802.11 standard is still protected in a communication between the first and second data transceivers. That is, robustness of copyright protection of data on an IEEE 802.11 network connected to the second data transceiver is ensured. In the case of transmitting data received by the transceiver means of the first data transceiver conforming to the IEEE 1394 standard, for example, in a wireless manner in compliance with the IEEE 802.11 standard, copyright protection of the data is also ensured.

In the data transceiver system of the present invention, decryption of the second transmission data in the second transmission mode and encryption of the second received data in the second reception mode are preferably performed in compliance with the IEEE 802.11 standard.

Then, the first data transceiver performs encryption or decryption in compliance with the IEEE 802.11 standard, so that the second data transceiver performs wireless transmission and reception of data which has been encrypted or decrypted based on the IEEE 802.11 standard.

### BRIEF DESCRIPTION OF THE DRAWINGS

FIG. 1 is a block diagram showing a configuration of a data transceiver according to a first embodiment of the present invention.

FIG. 2 is a diagram showing data transmission paths in a first transmission mode and a first reception mode, respectively, of the data transceiver of the first embodiment.

FIG. 3 is a diagram showing data transmission paths in a second transmission mode and a second reception mode, respectively, of the data transceiver of the first embodiment.

FIG. 4 is a diagram showing keys for encrypting or decrypting second transmission data in the second transmission mode of the data transceiver of the first embodiment.

FIG. 5 is a diagram showing keys for encrypting or decrypting second received data in the second reception mode of the data transceiver of the first embodiment.

FIG. 6 is a block diagram showing a configuration of a data transceiver according to a modified example of the first embodiment.

FIG. 7 is a block diagram showing a configuration of a data transceiver according to a second embodiment of the present invention.

FIG. 8A is a conceptual illustration showing a first selector constituting the data transceiver of the second embodiment. FIG. 8B is a conceptual illustration showing a second selector constituting the data transceiver of the second embodiment.

FIG. 9 is a block diagram showing a configuration of a data transceiver according to a first modified example of the second embodiment.

FIG. 10A is a table showing a register provided in the inside of a selector controlling section constituting the data transceiver of the first modified example of the second embodiment. FIG. 10B is a table showing a relationship between bits to be written in the register shown in FIG. 10A and operation of a selector.

FIG. 11 is a block diagram showing a configuration of a data transceiver according to a second modified example of the second embodiment and also showing a data transmission path in a second transmission mode.

FIG. 12 is a block diagram showing a configuration of the data transceiver of the second modified example of the second embodiment and also showing a data transmission path in a second reception mode.

FIG. 13 is a block diagram showing a configuration of a data transceiver according to a third modified example of the second embodiment.

FIG. 14 is a block diagram showing a configuration of a data transceiver according to a fourth modified example of the second embodiment.

FIG. 15 is a block diagram showing a configuration of a data transceiver according to a third embodiment of the present invention.

FIG. 16 is a conceptual illustration showing ON and OFF states of a first switch constituting the data transceiver of the third embodiment.

FIG. 17 is a block diagram showing a configuration of a data transceiver according to a modified example of the third embodiment.

FIG. 18A is a table showing a register provided in the inside of a switch controlling section constituting the data transceiver of the modified example of the third embodiment. FIG. 18B is a table showing a relationship between a bit to be written in the register shown in FIG. 18A and operation of a switch.

FIG. 19 is a block diagram showing a configuration of a data transceiver according to a fourth embodiment of the present invention and also showing data transmission paths in a third transmission mode and a third reception mode, respectively.

FIG. 20 is a diagram showing keys for encrypting or decrypting third transmission data and third received data in the third transmission mode and the third reception mode of the data transceiver of the fourth embodiment.

FIG. 21 is a block diagram showing a configuration of a data transceiver according to a first modified example of the fourth embodiment.

FIG. 22 is a block diagram showing a configuration of a data transceiver according to a second modified example of the fourth embodiment.

FIG. 23 is a block diagram showing a configuration of a data transceiver system according to a fifth embodiment of the present invention and also showing data transmission paths in a first transmission mode and a first reception mode, respectively.

FIG. 24 is a diagram showing a data transmission path in a second transmission mode of the data transceiver system of the fifth embodiment.

FIG. 25 is a diagram showing a data transmission path in a second reception mode of the data transceiver system of the fifth embodiment.

FIG. 26 is a block diagram showing a configuration of a data transceiver system according to a modified example of the fifth embodiment.

FIG. 27 is a block diagram showing a configuration of a known IEEE 1394 LSI.

FIG. 28 is a diagram showing a configuration of an IEEE 1394 packet transmitted or received in compliance with the IEEE 1394 standard.

FIG. 29 is a block diagram showing a configuration in which an IEEE 1394 device (D-VHS) and a wireless module are connected to the known IEEE 1394 LSI.

FIG. 30 is a block diagram specifically showing the configuration shown in FIG. 29 with reference to FIG. 28.

### DESCRIPTION OF THE PREFERRED EMBODIMENTS

Embodiment 1

Hereinafter, a data transceiver according to a first embodiment of the present invention will be described with reference to the drawings.

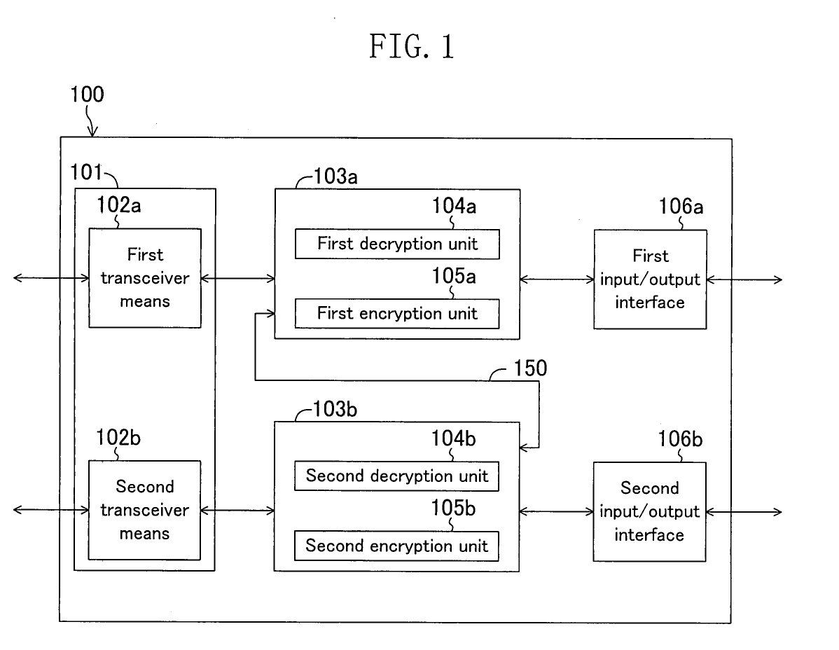

FIG. 1 is a block diagram showing a configuration of the data transceiver of the first embodiment.

As shown in FIG. 1, the data transceiver 100 includes: a transceiver means 101 for transmitting and receiving data; first and second encrypting/decrypting means 103a and 103b for encrypting and decrypting data; and first and second input/output interfaces 106a and 106b for input and output of data.

The transceiver means 101 further includes a first transceiver means 102a and a second transceiver means 102b. The first encrypting/decrypting means 103a includes a first decryption unit 104a for decrypting data and a first encryption unit 105a for encrypting data. The second encrypting/decrypting means 103b includes a second decryption unit 104b for decrypting data and a second encryption unit 105b for encrypting data.

The first encrypting/decrypting means 103a and the second encrypting/decrypting means 103b are connected to each other via a data transmission path 150.

Hereinafter, a data transmission path along which data (transmission data) input to the data transceiver 100 shown in FIG. 1 is transmitted and a data transmission path along which data (received data) is output will be described.

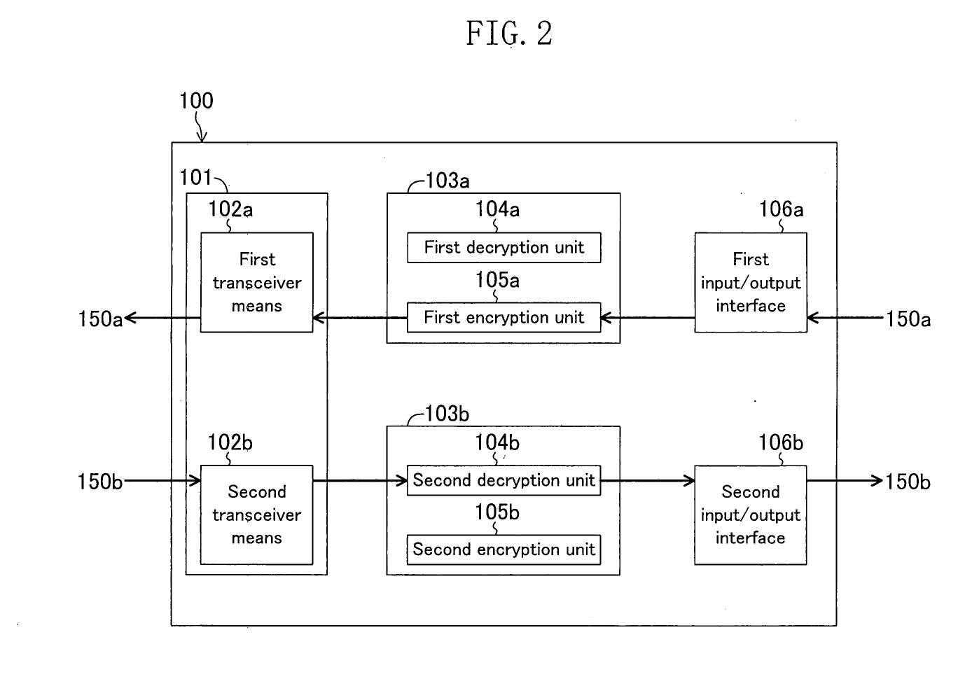

FIG. 2 is a diagram showing a data transmission path 150a for use in a first transmission mode in which unencrypted first transmission data is encrypted and then transmitted and a data transmission path 150b for use in a first reception mode in which encrypted first received data is decrypted and then output.

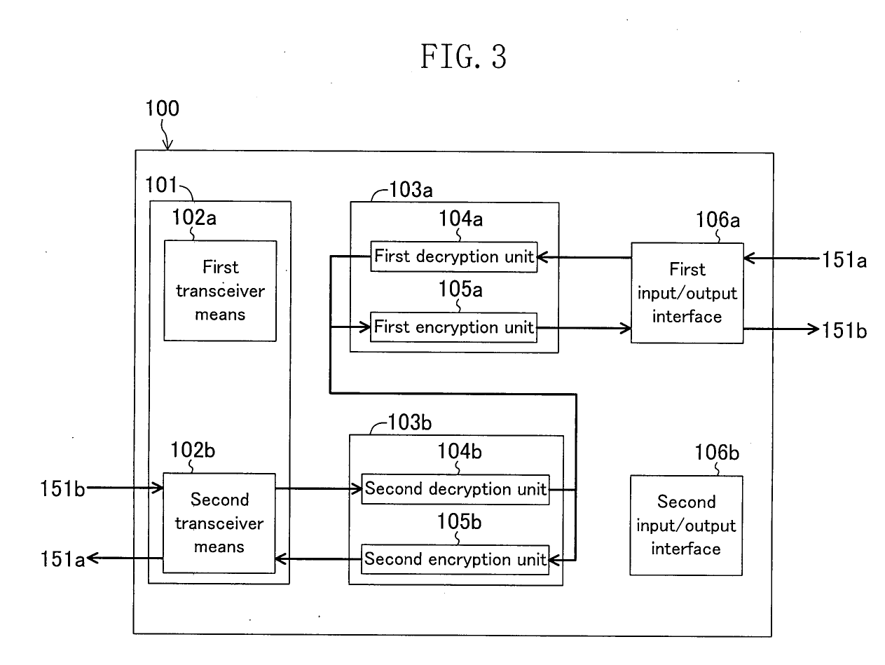

FIG. 3 is a diagram showing a data transmission path 151a for use in a second transmission mode in which encrypted second transmission data is reencrypted and then transmitted and a data transmission path 151b for use in a second reception mode in which encrypted second received data is reencrypted and then output.

As shown in FIG. 2, in the first transmission mode (the data transmission path 150a), the first transmission data input to the first input/output interface 106a is encrypted by the first encryption unit 105a in the first encrypting/decrypting means 103a, and then transmitted from the first transceiver means 102a. On the other hand, in the first reception mode (the data transmission path 150b), the first received data received by the second transceiver means 102b is decrypted by the second decryption unit 104b in the second encrypting/decrypting means 103b, and then output from the second input/output interface 106b.

As shown in FIG. 3, in the second transmission mode (the data transmission path 151a), the second transmission data input to the first input/output interface 106a is decrypted by the first decryption unit 104a in the first encrypting/decrypting means 103a, reencrypted by the second encryption unit 105b in the second encrypting/decrypting means 103b, and then transmitted from the second transceiver means 102b. On the other hand, in the second reception mode (the data transmission path 151b), the second received data received by the second transceiver means 102b is decrypted by the second decryption unit 104b in the second encrypting/decrypting means 103b, reencrypted by the first encryption unit 105a in the first encrypting/decrypting means 103a, and then output from the first input/output interface 106a.

Now, keys for encryption or decryption performed in the second transmission mode and the second reception mode will be described.

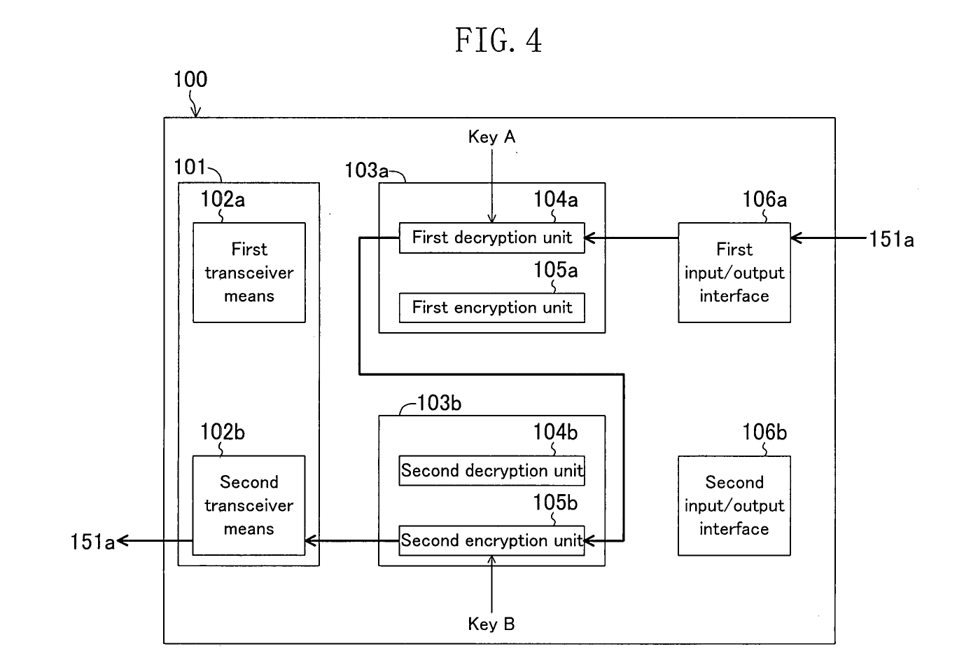

FIG. 4 is a diagram showing a decryption key for decryption of the second transmission data by the first decryption unit 104a and an encryption key for encryption of the second transmission data by the first encryption unit 105b in the second transmission mode.

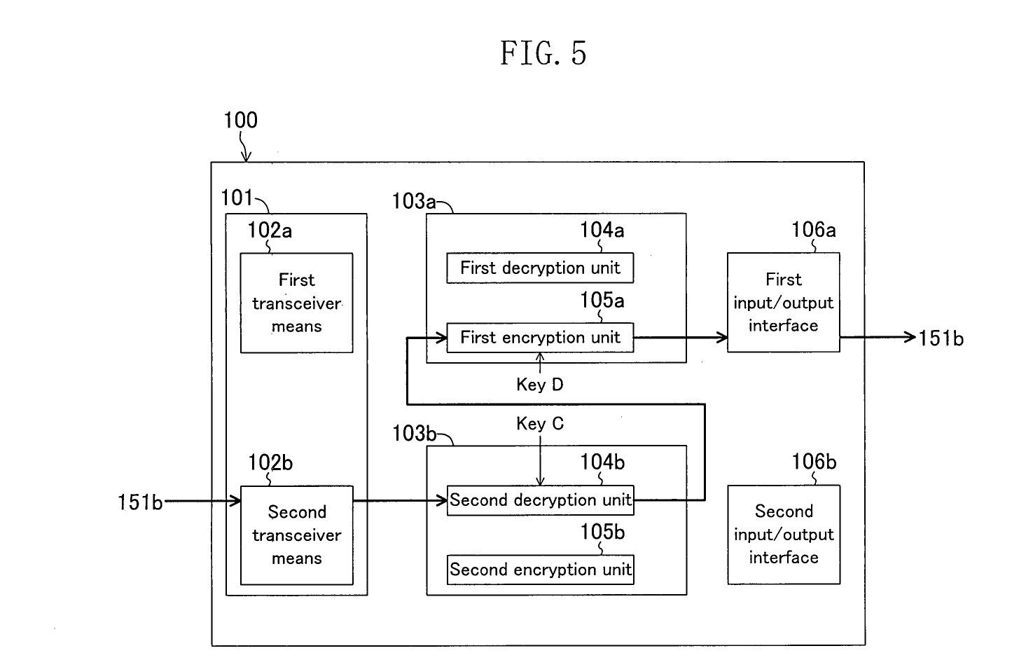

FIG. 5 is a diagram showing a decryption key for decryption of the second received data by the second decryption unit 104b and an encryption key for encryption of the second received data by the first encryption unit 105a in the second reception mode.

As shown in FIG. 4, in the second transmission mode (the data transmission path 151a), the second transmission data is decrypted by the first decryption unit 104a using a first decryption key Key A, and then encrypted by the second encryption unit 105b using a second encryption key Key B. On the other hand, as shown in FIG. 5, in the second reception mode (the data transmission path 151b), the second received data is decrypted by the second decryption unit 104b using a second decryption key Key C, and then encrypted by the first encryption unit 105a using a first encryption key Key D.

As described above, in the first embodiment, the data transceiver 100 is furnished with transceiver means, encrypting/decrypting means and input/output interfaces, in two sets that respectively include one of each of the components. Accordingly, transmission in the first transmission mode in which the first transmission data is encrypted and then transmitted and reception in the first reception mode in which the first received data is decrypted and then output are performed independently of each other. That is, the transmission in the first transmission mode and the reception in the first reception mode are performed independently of each other at the same time. Accordingly, if a DVD recorder, for example, is connected to the transceiver means 101, a process of playing back an MPEG image recorded on the DVD recorder and displaying the image on, for example, a display screen connected to the first input/output interface 106a and a process of recording, on the DVD recorder, a TV program input to the second input/output interface 106b are performed independently of each other at the same time. In addition, data which has been decrypted can be input and output to/from an external device, so that data transmission and reception suitable for the case of inputting and outputting data which does not need copyright protection, non-confidential data or the like to/from the external device is performed. The foregoing advantages are not limited to DVD recorders but are also obtained when a recorder which records data on a Blue-ray disk, for example, is used.

In the first embodiment, the encrypted second transmission data is reencrypted and then transmitted in the second transmission mode, whereas the encrypted second received data is reencrypted and then output in the second reception mode. Accordingly, data which is being input or output to/from an external device connected to the first and second input/output interfaces 106a and 106b is always in an encrypted state. This prevents a third party from illegally copying or intercepting received data output from the data transceiver 100. As a result, robustness of copyright protection of data on a network connected to the data transceiver 100 of this embodiment is ensured.

In the first embodiment, in the second transmission mode, encrypted transmission data is decrypted by the first decryption unit 104a in the first encrypting/decrypting means 103a using the first decryption key Key A, and then is reencrypted by the second encryption unit 105b in the second encrypting/decrypting means 103b using the second encryption key Key B, which is different from an encryption key used for encrypting the second transmission data, thereby transmitting the reencrypted data. On the other hand, in the second reception mode, encrypted second received data is decrypted by the second decryption unit 104b in the second encrypting/decrypting means 103b using the second decrypting key Key C, and then is reencrypted by the first encryption unit 105a in the first encrypting/decrypting means 103a using the first encryption key Key D, which is different from an encryption key used for encrypting the second received data, thereby outputting the reencrypted data. This ensures robustness of copyright protection of data on a network connected to the data transceiver 100 of this embodiment.

In the first embodiment, switching between the data transmission path in the first transmission mode and the data transmission path in the second transmission mode or between the data transmission path in the first reception mode and the data transmission path in the second reception mode is performed. Accordingly, in the case of outputting data which does not need copyright protection, output of the decrypted first received data is selected. In contrast, in the case of outputting data which needs copyright protection, output of the reencrypted second received data is selected. As a result, data is input and output or transmitted and received in a manner depending on the level of importance of the data.

In the first embodiment, switching between the data transmission paths enables reencryption of transmission data or received data. This eliminates the necessity of adding a new encryption circuit for reencrypting the transmission data or received data. That is, it is unnecessary to increase the circuit scale. Accordingly, a data transceiver capable of preventing illegal copying and intercepting is implemented with the existing circuit scale maintained. In addition, the unnecessity of adding a new encryption circuit also eliminates the necessity of designing a new transceiver circuit. Accordingly, the period required to design a transceiver circuit is shortened and the design cost is reduced.

The data transceiver 100 of the first embodiment is preferably integrated on a single integrated circuit.

Then, the data transceiver 100 is implemented as LSI integrated on a single integrated circuit. Accordingly, it is possible to prevent illegal copying or intercepting by a third party before the second received data decrypted by the second encrypting/decrypting means 103b is reencrypted by the first encrypting/decrypting means 103a, for example.

In the first embodiment, in the second transmission mode, the second transmission data is decrypted by the first decryption unit 104a, and then reencrypted by the second encryption unit 105b. Alternatively, the second transmission data may be decrypted by the second decryption unit 104b and then reencrypted by the first encryption unit 105a. In the second reception mode, the second received data is decrypted by the second decryption unit 104b, and then reencrypted by the first encryption unit 105a. Alternatively, the second received data may be decrypted by the first decryption unit 104a and then reencrypted by the second encryption unit 105b.

The data transceiver 100 of the first embodiment is furnished with transceiver means, encrypting/decrypting means and input/output interfaces, in two sets that respectively include one of each of the components. The data transceiver 100 may, however, be furnished with three or more of the sets.

(Modified Example of Embodiment 1)

Hereinafter, a data transceiver according to a modified example of the first embodiment will be described with reference to the drawings.

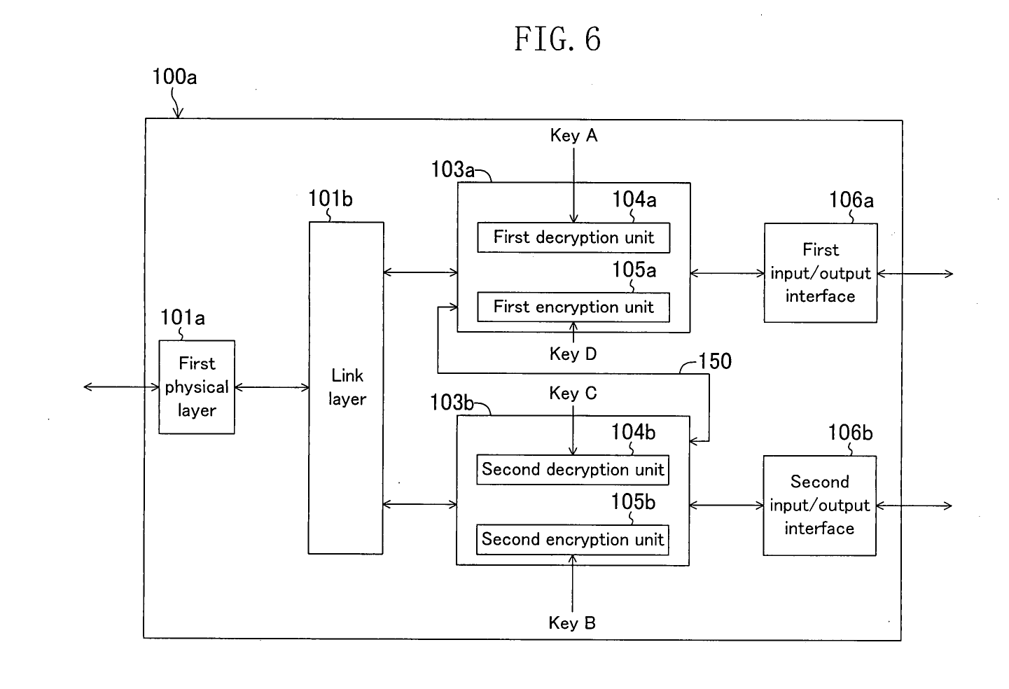

FIG. 6 is a block diagram showing a configuration of the data transceiver of the modified example of the first embodiment. In FIG. 6, the same members as those of the data transceiver 100 of the first embodiment shown in FIG. 1 are identified by the same reference numerals.

As shown in FIG. 6, a data transceiver 100a according to the modified example of the first embodiment is characterized in that the transceiver means 101 of the data transceiver 100 of the first embodiment shown in FIG. 1 is constituted by a first physical layer 101a and a link layer 101b conforming to the IEEE 1394 standard.

Accordingly, in this modified example, transmission and reception are performed in compliance with the IEEE 1394 standard. Therefore, even if data received from an IEEE 1394 network is output to an external device connected to a first or second input/output interface 106a or 106b, the received data is reencrypted before being output to the external device. As a result, robustness of copyright protection of data on the IEEE 1394 network is ensured.

Embodiment 2

Hereinafter, a data transceiver according to a second embodiment of the present invention will be described with reference to the drawings.

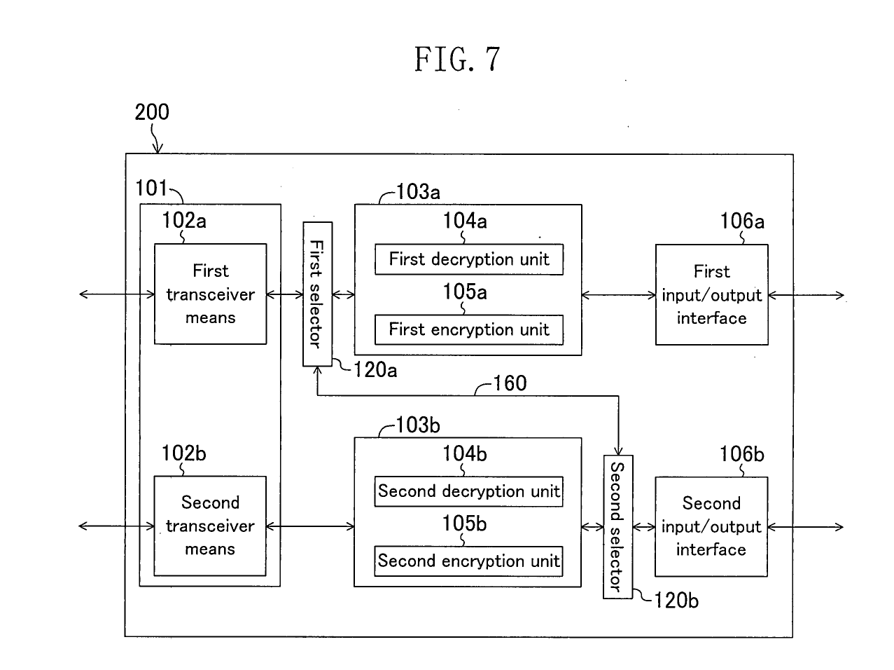

The data transceiver of the second embodiment is characterized by further including two selectors in addition to the configuration of the data transceiver 100 of the first embodiment shown in FIG. 1. FIG. 7 shows a configuration of the data transceiver of the second embodiment.

FIG. 7 is a block diagram showing the configuration of the data transceiver of the second embodiment. In FIG. 7, the same members as those of the data transceiver 100 of the first embodiment shown in FIG. 1 are identified by the same reference numerals.

As shown in FIG. 7, the data transceiver 200 includes: a first selector 120a on a data transmission path between a first transceiver means 102a and a first encrypting/decrypting means 103a; and a second selector 120b on a data transmission path between a second encrypting/decrypting means 103b and a second input/output interface 106b. The first and second selectors 120a and 120b are connected to each other via a data transmission path 160.

In FIG. 7, the first and second selectors 120a and 120b are connected directly to each other via the data transmission path 160. Alternatively, another circuit block (e.g., an additional encrypting/decrypting means or selector) may be interposed in the data transmission path 160.

Now, specific operation of the first and second selectors 120a and 120b will be described.

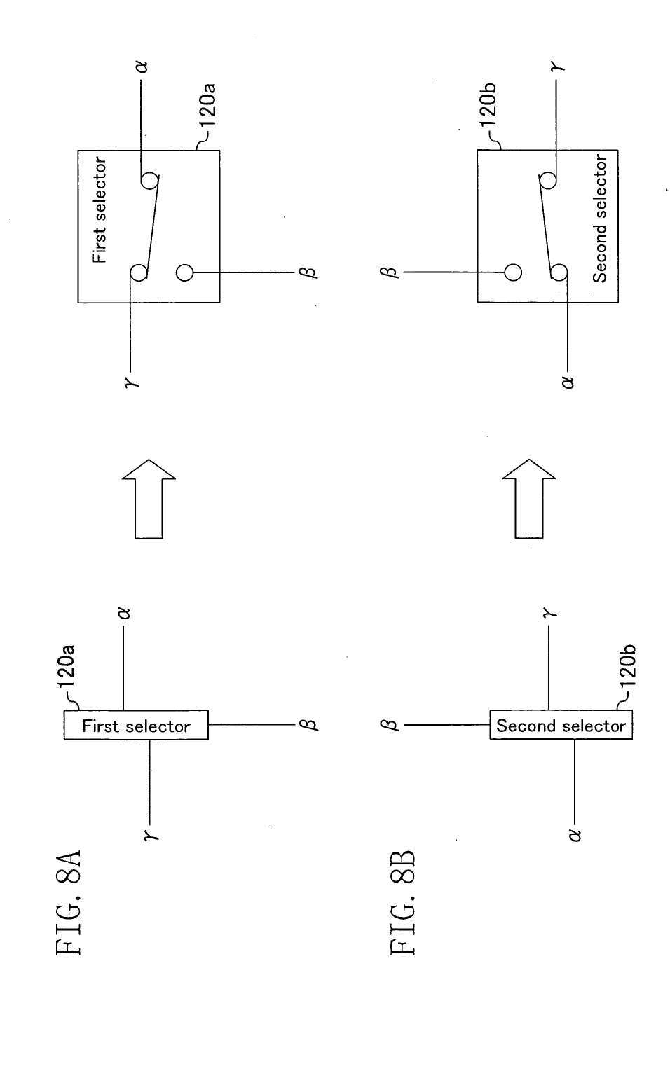

FIG. 8A is a conceptual illustration of the specific operation of the first selector 120a. FIG. 8B is a conceptual illustration of the specific operation of the second selector 120b.

As shown in FIG. 8A, the first selector 120a has three data transmission paths. The first encrypting/decrypting means 103a is provided on one of the data transmission paths represented by α, the second selector 120b is provided on another data transmission path represented by β, and the first transceiver means 102a is provided on the other data transmission path represented by γ.

On the other hand, as shown in FIG. 8B, the second selector 120b also has three data transmission paths. The second encrypting/decrypting means 103b is provided on one of the data transmission paths represented by α, the first selector 120a is provided on another data transmission paths represented by β, and the second input/output interface 106b is provided on the other data transmission path represented by γ.

Accordingly, to implement the first transmission mode and the first reception mode described in the first embodiment, the first selector 120a operates so as to connect the data transmission path represented by γ and the data transmission path represented by α to each other. In this manner, the first transceiver means 102a and the first encrypting/decrypting means 103a are connected to each other. On the other hand, to implement the first transmission mode and the first reception mode, the second selector 120b operates so as to connect the data transmission path represented by α and the data transmission path represented by γ to each other. In this manner, the second encrypting/decrypting means 103b and the second input/output interface 106b are connected to each other.

In the second transmission mode and the second reception mode, each of the first and second selectors 120a and 120b operates so as to connect the data transmission path represented by α and the data transmission path represented by β to each other. In this manner, the first encrypting/decrypting means 103a and the second encrypting/decrypting means 103b are connected to each other.

Through the aforementioned operation, in the first transmission mode, first transmission data input to the first input/output interface 106a passes through the first encrypting/decrypting means 103a and the first selector 120a in this order and then is transmitted from the first transceiver means 102a. On the other hand, in the first reception mode, first received data received by the second transceiver means 102b passes through the second encrypting/decrypting means 103b and the second selector 120b in this order and then is output from the first input/output interface 106a.

In the second transmission mode, second transmission data input to the first input/output interface 106a passes through the first encrypting/decrypting means 103a, the first selector 120a, the second selector 120b and the second encrypting/decrypting means 103b in this order and then is transmitted from the second transceiver means 102b. On the other hand, in the second reception mode, second received data received by the second transceiver means 102b passes through the second encrypting/decrypting means 103b, the second selector 120b, the first selector 120a and the first encrypting/decrypting means 103a in this order and then is output from the first input/output interface 106a.

In this manner, in the second embodiment, the first and second selectors 120a and 120b for switching between the data transmission paths are provided, so that switching between the data transmission paths in the first transmission mode and the first reception mode and the data transmission paths in the second transmission mode and the second reception mode is easily performed. Accordingly, in the case of inputting or outputting data which does not need copyright protection, the data transmission paths for the first transmission mode and the first reception mode are selected, thus inputting or outputting decrypted data. In contrast, in the case of inputting or outputting data which needs copyright protection, the data transmission paths for the second transmission mode and the second reception mode are selected, so that encrypted date is input or output with safety.

In the second embodiment, the function of reencrypting transmission data or received data is implemented by the selectors for switching between the data transmission paths, so that it is unnecessary to design a new data transceiver exclusively for reencryption to which an encryption circuit for reencryption is added. In addition, the unnecessity of adding a new encryption circuit for reencrypting transmission data or received data allows an existing circuit scale to be maintained. As a result, the period required to design a transceiver circuit is shortened and the design cost is reduced.

In the second embodiment, the first selector 120a is provided on the data transmission path between the first transceiver means 102a and the first encrypting/decrypting means 103a. Alternatively, the first selector 120a may be provided on a transmission path between the first encrypting/decrypting means 103a and the first input/output interface 106a. In such a case, it is sufficient to provide the second selector 120b on a data transmission path between the second transceiver means 102b and the second encrypting/decrypting means 103b.

In the second embodiment, another switching means for switching between data transmission paths may be provided instead of the first and second selectors 120a and 120b for switching between the data transmission paths.

(Modified Example 1 of Embodiment 2)

Hereinafter, a data transceiver according to a first modified example of the second embodiment will be described with reference to the drawings.

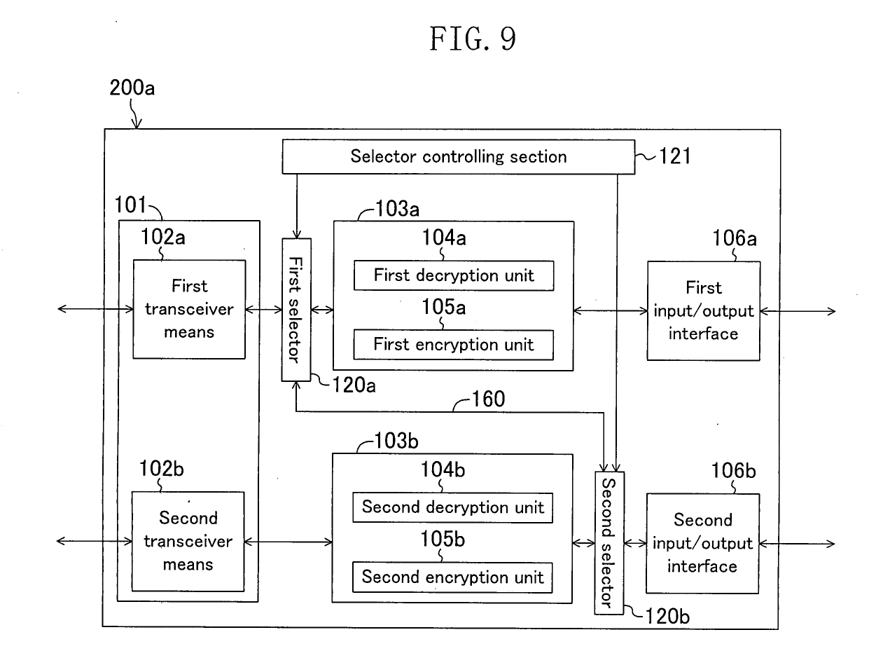

FIG. 9 is a block diagram showing a configuration of the data transceiver of the first modified example of the second embodiment. In FIG. 9, the same members as those of the data transceiver 200 of the second embodiment shown in FIG. 7 are identified by the same reference numerals.

As shown in FIG. 9, the first modified example of the second embodiment is characterized by further including a selector controlling section 121 in addition to the configuration of the data transceiver 200 shown in FIG. 7.

The selector controlling section 121 controls the first and second selectors 120a and 120b, thereby determining data transmission paths to be selected by the first and second selectors 120a and 120b.

Hereinafter, operation of the selectors controlled by the selector controlling section 121 will be described with reference to FIGS. 8 through 10.

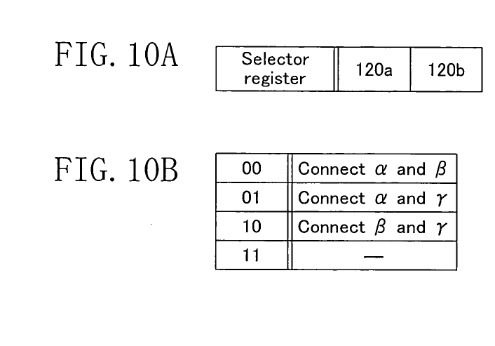

FIG. 10A is a table showing a configuration of a register provided in the inside of the selector controlling section 121 to control the first and second selectors 120a and 120b.

FIG. 10B is a table showing control with the register configuration shown in FIG. 10A when a selector is controlled using two bits.

As shown in FIG. 10A, two registers associated with the respective first and second selectors 120a and 120b are provided in the inside of the selector controlling section 121 so as to control switching between data transmission paths by the first and second selectors 120a and 120b. Control information of two bits is written in each of the registers by a microcomputer, for example. Specifically, to connect the data transmission path represented by γ and the data transmission path represented by α to each other using the first selector 120a shown in FIG. 8A, bits “10” shown in FIG. 10B are written in the register associated with the first selector 120a shown in FIG. 1A. In this case, if bits “10” are written in the register associated with the second selector 120b shown in FIG. 10A at the same time, the data transmission path represented by α and the data transmission path represented by γ shown in FIG. 8B are connected to each other. In this manner, the data transmission paths in the first transmission mode and the first reception mode are selected in the data transceiver 200a. In the same manner, if appropriate bits are written in the registers shown in FIG. 10A, the data transmission paths in the second transmission mode and the second reception mode are also selected.

As described above, in the first modified example of the second embodiment, the registers for controlling the first and second selectors 120a and 120b are provided in the inside of the selector controlling section 121, thus ensuring determination of switching between the data transmission paths by the first and second selectors 120a and 120b.

(Modified Example 2 of Embodiment 2)

Hereinafter, a data transceiver according to a second modified example of the second embodiment will be described with reference to the drawings.

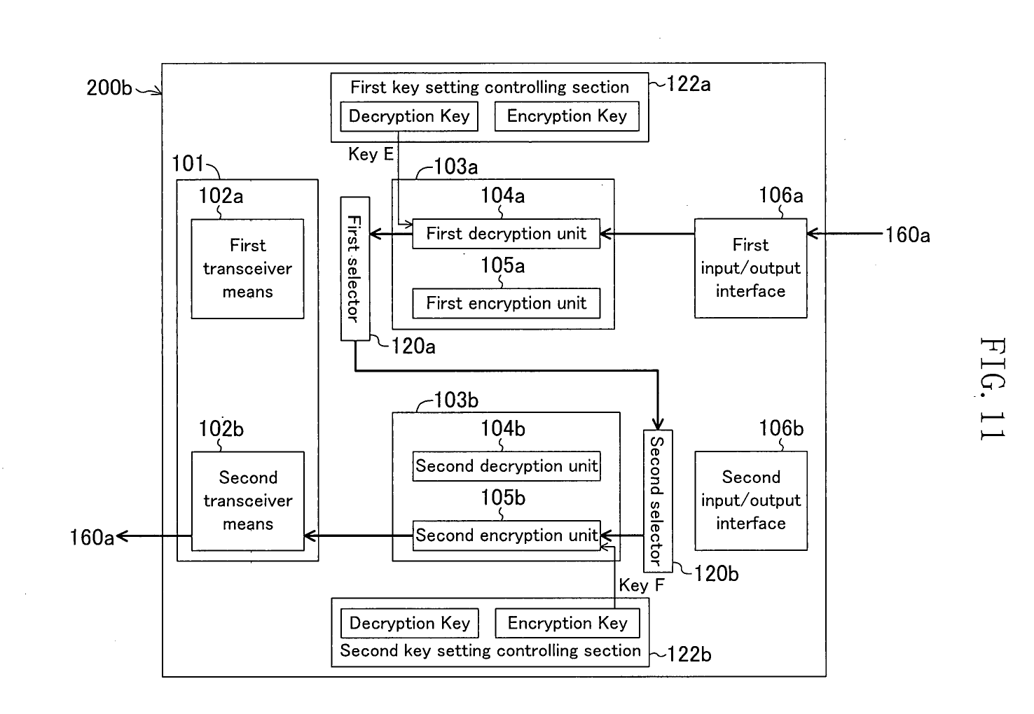

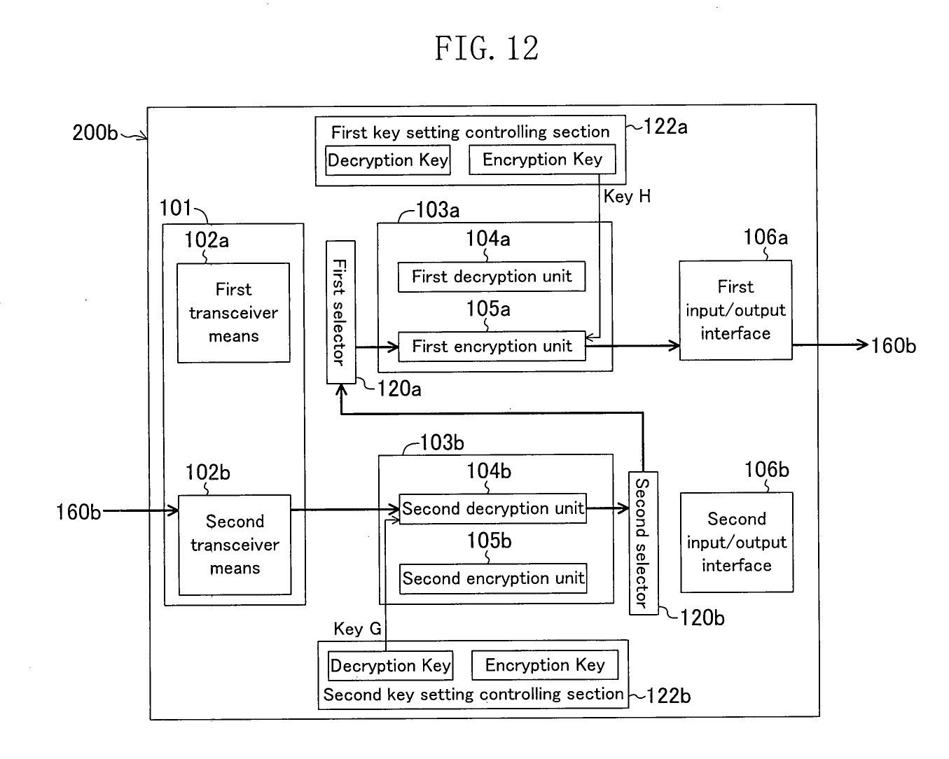

FIGS. 11 and 12 are block diagrams showing a configuration of the data transceiver of the second modified example of the second embodiment. In FIGS. 11 and 12, the same members as those of the data transceiver 200 of the second embodiment shown in FIG. 7 are identified by the same reference numerals.

FIG. 11 also shows a second transmission mode of the data transceiver of the second modified example of the second embodiment. FIG. 12 also shows a second reception mode of the data transceiver of the second modified example of the second embodiment.

As shown in FIGS. 11 and 12, the data transceiver of the second modified example of the second embodiment is characterized by further including first and second key setting controlling sections 122a and 122b for generating keys for data encryption or decryption and setting the generated keys in the encrypting/decrypting means, in addition to the configuration of the data transceiver 200 of the second embodiment shown in FIG. 7.

Specifically, as shown in FIG. 11, for example, in the second transmission mode (the data transmission path 160a), the first decryption unit 104a in the first encrypting/decrypting means 103a decrypts second transmission data input to the first input/output interface 106a using a third decryption key Key E generated by the first key setting controlling section 122a. Thereafter, the second encryption unit 105b in the second encrypting/decrypting means 103b reencrypts the second transmission data which has passed through the first selector 120a and the second selectors 120b using a fourth encryption key Key F generated by the second key setting controlling section 122b.

As shown in FIG. 12, in the second reception mode (the data transmission path 160b), the second decryption unit 104b in the second encrypting/decrypting means 103b decrypts second received data received by the second transceiver means 102b using a fourth decryption key Key G generated by the second key setting controlling section 122b. Thereafter, the first encryption unit 105a in the first encrypting/decrypting means 103a reencrypts the second received data which has passed through the second selector 120b and the first selector 120a in this order, using a third encryption key Key H generated by the first key setting controlling section 122a.

As described above, in the second modified example of the second embodiment, the data transceiver 200b includes: the first key setting controlling section 122a for generating keys for data encryption or decryption and setting the generated keys in the first encrypting/decrypting means 103a, and the second key setting controlling section 122b for generating keys for data encryption or decryption and setting the generated keys in the second encrypting/decrypting means 103b. Specifically, the types of keys used for encrypting and decrypting data in the first or second encrypting/decrypting means 103a or 103b are selected and whether the selected keys are set or not is determined. Accordingly, copyright of data which is input or output to/from a connected external device is appropriately protected in a manner depending on the level of importance of the data. In addition, the transceiver of this modified example can process data in accordance with an encryption or decryption method of an external device to which data is to be transmitted or output. Moreover, the first and second key setting controlling sections 122a and 122b determine whether keys for encryption or decryption are set or not, so that the transceiver of this modified example is applicable to a case where encryption or decryption is unnecessary.

In the second modified example of the second embodiment, the data transceiver 200b includes two key setting controlling sections, i.e., the first and second key setting controlling sections 122a and 122b. Instead, the data transceiver 200b may include one key setting controlling section for commonly controlling keys for encryption or decryption performed in both the first and second encrypting/decrypting means 103a and 103b.

(Modified Example 3 of Embodiment 2)

Hereinafter, a data transceiver according to a third modified example of the second embodiment will be described with reference to the drawings.

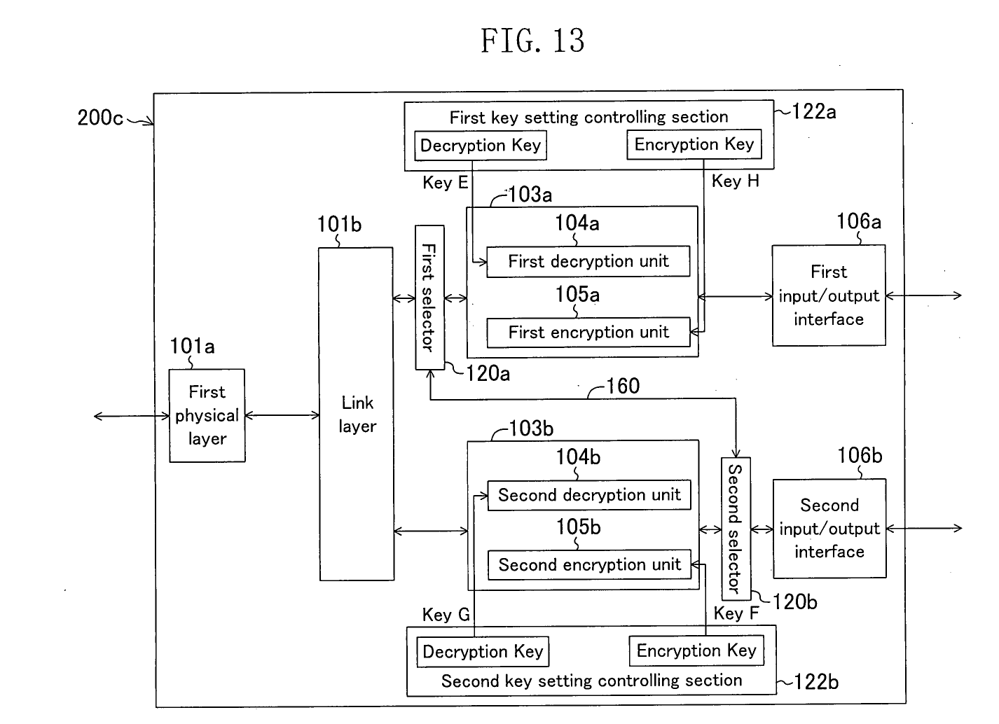

FIG. 13 is a block diagram showing a configuration of the data transceiver of the third modified example of the second embodiment. In FIG. 13, the same members as those of the data transceiver 100a of the modified example of the first embodiment shown in FIG. 6 or the data transceiver 200 of the second modified example of the second embodiment shown in FIGS. 12 and 13 are identified by the same reference numerals.

As shown in FIG. 13, a data transceiver 200c according to the third modified example of the second embodiment is characterized in that the transceiver means 101 of the data transceiver 200b of the second modified example of the second embodiment shown in FIGS. 11 and 12 is constituted by a first physical layer 101a and a link layer 101b conforming to the IEEE 1394 standard.

Accordingly, in the third modified example of the second embodiment, transmission and reception are performed in compliance with the IEEE 1394 standard. Therefore, even if data received from a connected IEEE 1394 network is input or output to/from an external device, advantages of the second modified example of the second embodiment are obtained as intended. This ensures robustness of copyright protection of data on the IEEE 1394 network.

In the third modified example of the second embodiment, the types of keys for encryption or decryption are selected by the first or second key setting controlling section 122a or 122b. Accordingly, in transmitting data to an external device connected to an IEEE 1394 network, even in the case of transmission in the second transmission mode, for example, if the second key setting controlling section 122b generates the fourth encryption key Key F conforming to the IEEE 1394 standard and the generated fourth encryption key Key F is set in the second encryption unit 105b, the second transmission data which has been encrypted in compliance with the IEEE 1394 standard is transmitted. On the other hand, even in the case of reception in the second reception mode, if the second key setting controlling section 122b generates the fourth decryption key Key G conforming to the IEEE 1394 standard and the generated fourth decryption key Key G is set in the second decryption unit 104b, data which has been encrypted in compliance with the IEEE 1394 standard is decrypted.

In the third modified example of the second embodiment, the data transceiver 200c may further include a selector controlling section for controlling the first and second selectors 120a and 120b for determining the data transmission paths.

(Modified Example 4 of Embodiment 2)

Hereinafter, a data transceiver according to a fourth modified example of the second embodiment will be described with reference to the drawings.

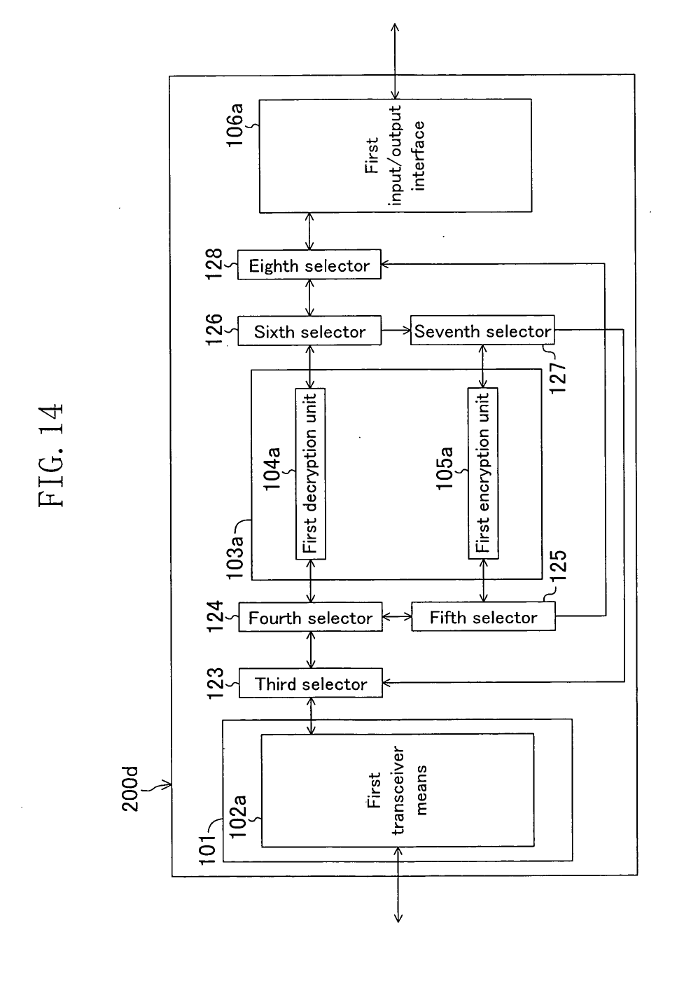

FIG. 14 is a block diagram showing a configuration of the data transceiver of the fourth modified example of the second embodiment. In FIG. 14, the same members as those of the data transceiver 200 of the second embodiment shown in FIG. 7 are identified by the same reference numerals.

As shown in FIG. 14, a data transceiver 200d according to the fourth modified example of the second embodiment is characterized by including six selectors for switching between data transmission paths to perform reencryption of transmission data or received data with one encrypting/decrypting means. Specifically, the data transceiver 200d includes: a first transceiver means 102a; a first encrypting/decrypting means 103a constituted by a first decryption unit 104a and a first encryption unit 105a; a first input/output interface 106a; and third through eight selectors 123 through 128.

Hereinafter, four cases of data transmission paths for transmission data and received data according to this modified example will be described

In a first transmission mode in this modified example, first transmission data input to the first input/output interface 106a passes through the eighth selectors 128, the sixth selector 126 and the seventh selector 127 in this order, and then is encrypted by the first encryption unit 105a in the first encrypting/decrypting means 103a. Thereafter, the encrypted first transmission data passes through the fifth selector 125, the fourth selector 124 and the third selector 123 in this order, and then is transmitted from the first transceiver means 102a. On the other hand, in a first reception mode, first received data received by the first transceiver means 102a passes through the third selector 123 and the fourth selector 124 in this order, and then is decrypted by the first decryption unit 104a in the first encrypting/decrypting means 103a. Thereafter, the decrypted first received data passes through the sixth selector 126 and the eighth selector 128 in this order, and then is output from the first input/output interface 106a.

In a second transmission mode, second transmission data input to the first input/output interface 106a passes through the eighth selector 128 and sixth selector 126 in this order, and then is decrypted by the first decryption unit 104a in the first encrypting/decrypting means 103a. Thereafter, the decrypted second transmission data passes through the fourth selector 124 and the fifth selector 125 in this order, and then is reencrypted by the first encryption unit 105a in the first encrypting/decrypting means 103a. Then, the reencrypted second transmission data passes through the seventh selector 127 and the third selector 123 in this order, and then is transmitted from the first transceiver means 102a. On the other hand, in a second reception mode, second received data received by the first transceiver means 102a passes through the third selector 123 and the fourth selector 124 in this order, and then is decrypted by the first decryption unit 104a in the first encrypting/decrypting means 103a. Thereafter, the decrypted second received data passes through the sixth selector 126 and the seventh selector 127 in this order, and then is reencrypted by the first encryption unit 105a in the first encrypting/decrypting means 103a. Then, the reencrypted second received data passes through the fifth selector 125 and the eighth selector 128 in this order, and then is output from the first input/output interface 106a.

As described above, in the fourth modified example of the second embodiment, even in a data transceiver having only one encrypting/decrypting means (103a), the six selectors, i.e., the third through eighth selectors 123 through 128, allow transmission data or received data to be reencrypted. This prevents a third party from illegally copying or intercepting data which is input or output to/from an external device. As a result, robustness of copyright protection of data on a network connected to the data transceiver 200d of this modified example is ensured.

In the fourth modified example of the second embodiment, switching between data transmission paths is easily performed using the third through eighth selectors 123 through 128. Accordingly, in the case of outputting data which does not need copyright protection, the data transmission path for use in the first reception mode is selected, thereby outputting decrypted first received data. In contrast, in the case of outputting data which needs copyright protection, the data transmission path for use in the second reception mode is selected, thereby outputting reencrypted second received data.

In the fourth modified example of the second embodiment, the function of reencrypting transmission data or received data is implemented by the selectors for switching between the data transmission paths, so that it is unnecessary to design a new data transceiver exclusively for reencryption to which an encryption circuit for reencryption is added. In addition, the unnecessity of adding a new encryption circuit for reencrypting transmission data or received data allows an existing circuit scale to be maintained. As a result, the period required to design a transceiver circuit is shortened and the design cost is reduced.

In the fourth modified example of the second embodiment, a selector controlling section for controlling the third through eighth selectors 123 through 128 is preferably provided.

In the fourth modified example of the second embodiment, a key setting controlling section for setting a decryption key in the first decryption unit 104a and an encryption key in the first encryption unit 105a is preferably further provided.

In the fourth modified example of the second embodiment, if received data does not need to be reencrypted in the second reception mode, the third and fifth selectors 123 and 125 may be omitted. On the other hand, if transmission data does not need to be reencrypted in the second transmission mode, the seventh and eighth selectors 127 and 128 may be omitted.

In the fourth modified example of the second embodiment, the first transceiver means 102a preferably performs transmission and reception in compliance with the IEEE 1394 standard.

Embodiment 3

Hereinafter, a data transceiver according to a third embodiment of the present invention will be described with reference to the drawings.

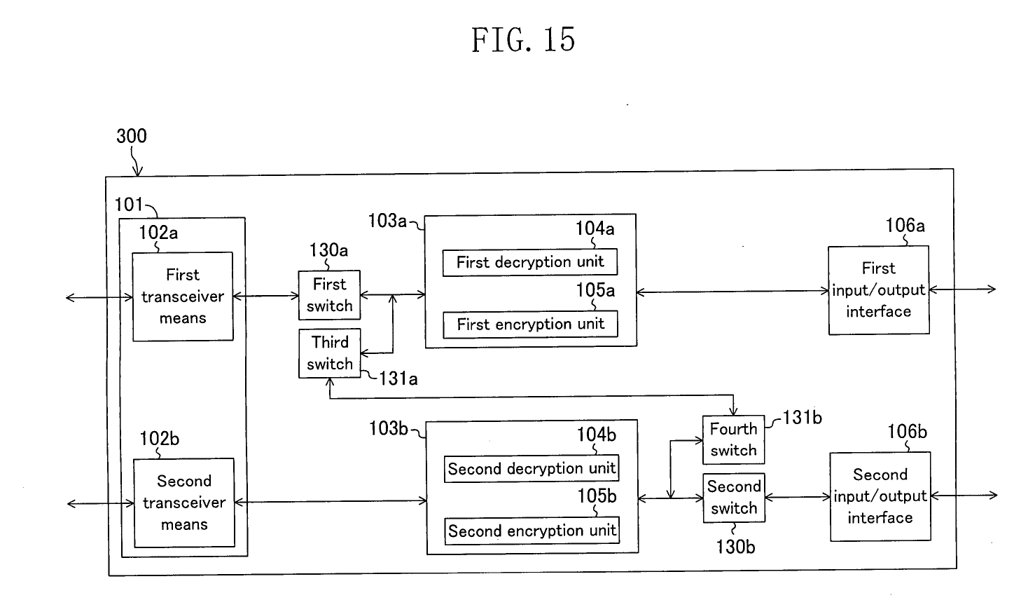

The data transceiver of the third embodiment is characterized by further including four switches in addition to the configuration of the data transceiver 100 of the first embodiment shown in FIG. 1. FIG. 15 shows a configuration of the data transceiver of the third embodiment.

FIG. 15 is a block diagram showing a configuration of the data transceiver of the third embodiment. In FIG. 15, the same members as those of the data transceiver 100 of the first embodiment shown in FIG. 1 are identified by the same reference numerals.

As shown in FIG. 15, the data transceiver 300 of this embodiment includes: a first switch 130a on a data transmission path between a first transceiver means 102a and a first encrypting/decrypting means 103a; and a second switch 130b on a data transmission path between a second encrypting/decrypting means 103b and a second input/output interface 106b. The data transceiver 300 further includes: third and fourth switches 131a and 131b on a data transmission path between the first switch 130a and the first encrypting/decrypting means 103a and a transmission path between the second encrypting/decrypting means 103b and the second switch 130b, respectively.

Now, specific operation of the first switch 130a, the second switch 130b, the third switch 131a and the fourth switch 131b will be described.

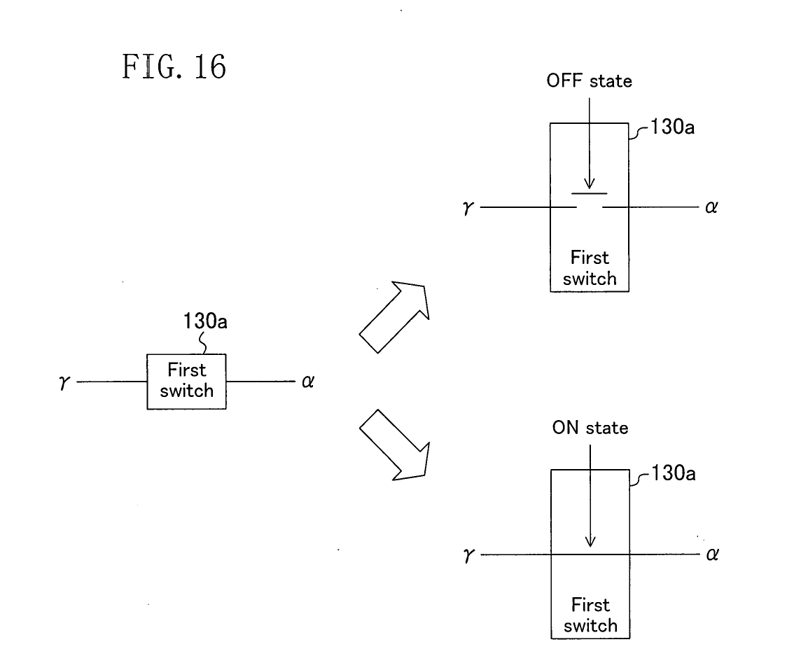

FIG. 16 is a conceptual illustration of specific operation of the first switch 130a.

As shown in FIG. 16, the first switch 130a has two data transmission paths. The first encrypting/decrypting means 103a is provided on one of the data transmission paths represented by α and the first transceiver means 102a is provided on the other data transmission path represented by γ.

As shown in FIG. 16, the first switch 130a takes two states, i.e., an OFF state in which the data transmission path represented by α and the data transmission path represented by γ are not connected to each other and an ON state in which the data transmission path represented by α and the data transmission path represented by γ are connected to each other. In the OFF state, no current flows between the data transmission path represented by α and the data transmission path represented by γ. On the other hand, in the ON state, current flows between the data transmission path represented by α and the data transmission path represented by γ. The OFF state and the ON state of the first switch 130a are shown in FIG. 16. Each of the second, third and fourth switches 130b, 131a and 131b also takes an OFF state and an ON state.

If the first and second switches 130a and 130b are turned ON (connecting state) and the third and fourth switches 131a and 131b are turned OFF (disconnecting state), data transmission or reception in the first transmission mode or the first reception mode described in the first embodiment is performed.

In contrast, if the first and second switches 130a and 130b are turned OFF (disconnecting state) and the third and fourth switches 131a and 131b are turned ON (connecting state), data transmission or reception in the second transmission mode or the second reception mode described in the first embodiment is performed.

If the first, third and fourth switches 130a, 131a and 131b are turned ON and the second switch 130b is turned OFF, data transmissions in the respective first and second transmission modes are performed at the same time or data receptions in the respective first and second reception modes are performed at the same time.

As described above, in the third embodiment, the first, second, third and fourth switches 130a, 130b, 131a and 131b for switching the connection states between ON and OFF are provided. Accordingly, if the switches each in the ON or OFF state are combined, switching between the data transmission paths for the first transmission mode and the first reception mode and the data transmission paths for the second transmission mode and the second reception mode is performed easily. In the case of inputting or outputting data which does not need copyright protection, the data transmission paths for the first transmission mode and the first reception mode are selected so that decrypted data is input or output. In contrast, in the case of inputting or outputting data which needs copyright protection, the data transmission paths for the second transmission mode and the second reception mode are selected so that encrypted data is input or output with safety.

In the third embodiment, combination of the ON and OFF states of the first, second, third and fourth switches 130a, 130b, 131a and 131b allows data transmissions in the first and second transmission modes to be performed at the same time. Data receptions in the first and second reception mode are also performed at the same time.

In the third embodiment, the function of reencrypting transmission data or received data is implemented by a combination of switches each switching between ON and OFF states, so that it is unnecessary to design a new data transceiver exclusively for reencryption to which an encryption circuit for reencryption is added. In addition, the unnecessity of adding a new encryption circuit for reencrypting transmission data or received data allows an existing circuit scale to be maintained. As a result, the period required to design a transceiver circuit is shortened and the design cost is reduced.

(Modified Example of Embodiment 3)

Hereinafter, a data transceiver according to a modified example of the third embodiment will be described with reference to the drawings.

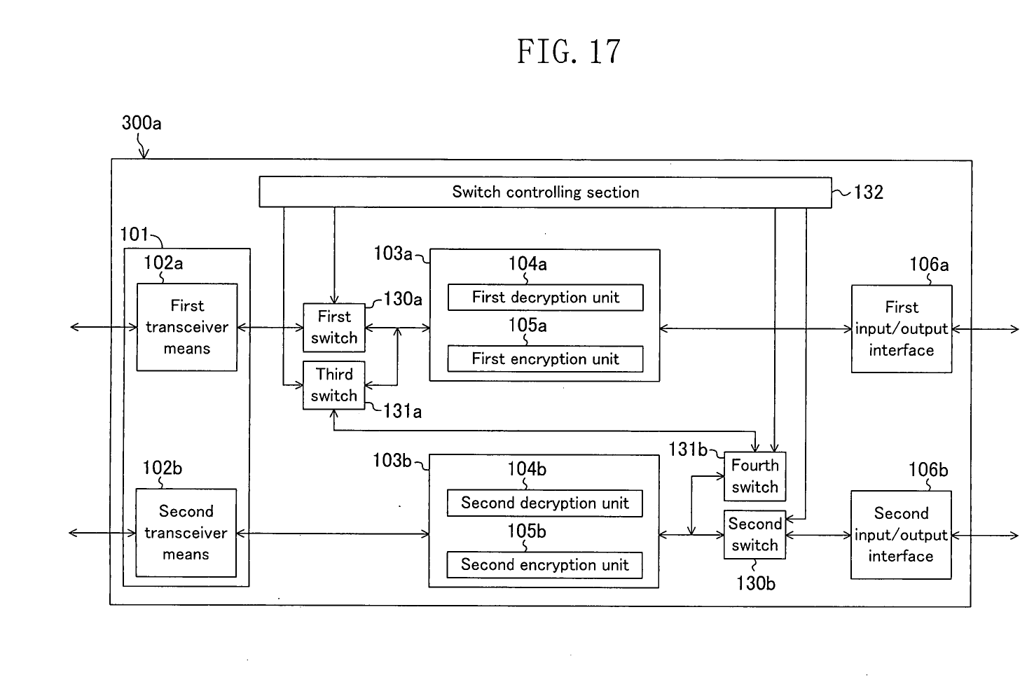

FIG. 17 is a block diagram showing a configuration of the data transceiver of the modified example of the third embodiment. In FIG. 17, the same members as those of the data transceiver 300 shown in FIG. 15 are identified by the same reference numerals.

As shown in FIG. 17, the data transceiver of the modified example of the third embodiment is characterized by including a switch controlling section 132 in addition to the configuration of the data transceiver 300 shown in FIG. 15.

The switch controlling section 132 determines switching between ON and OFF states of the first, second, third and fourth switches 130a, 130b, 131a and 131b.

Hereinafter, operation of the switches controlled by the switch controlling section 132 will be described specifically.

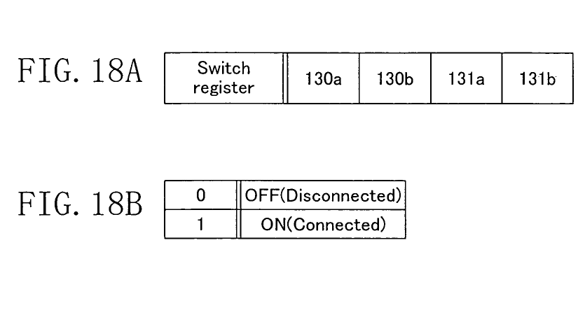

FIG. 18A is a table showing a configuration of a register provided in the inside of the switch controlling section 132 to control the first, second, third and fourth switches 130a, 130b, 131a and 131b.

FIG. 18B is a table showing control with the register configuration shown in FIG. 18A when a switch is controlled using one bit.

As shown in FIG. 18A, four registers are provided in the inside of the switch controlling section 132 to control operation of the respective the first, second, third and fourth switches 130a, 130b, 131a and 131b. Control information of one bit is written in each of the registers by a microcomputer, for example.

Specifically, to connect the data transmission path represented by α and the data transmission path represented by γ using the first switch 130a shown in FIG. 15, bit “1” is written in the register associated with the first switch 130a shown in FIG. 18A by a microcomputer, for example. In this case, if bit “1” is written in the register associated with the second switch 130b shown in FIG. 18A at the same time, the second encrypting/decrypting means 103b and the second input/output interface 106b are connected to each other. In this manner, the data transmission paths in the first transmission mode and the first reception mode are selected in the data transceiver 300a. In the same manner, if appropriate bits are written in the registers shown in FIG. 18A, the data transmission paths in the second transmission mode and the second reception mode are also selected.

As described above, in the modified example of the third embodiment, registers for controlling the respective first, second, third and fourth switches 130a, 130b, 131a and 131b are provided in the inside of the switch controlling section 132, thus ensuring switching between data transmission paths using a combination of ON and OFF states of the switches.

Embodiment 4

Hereinafter, a data transceiver according to a fourth embodiment of the present invention will be described with reference to the drawings.

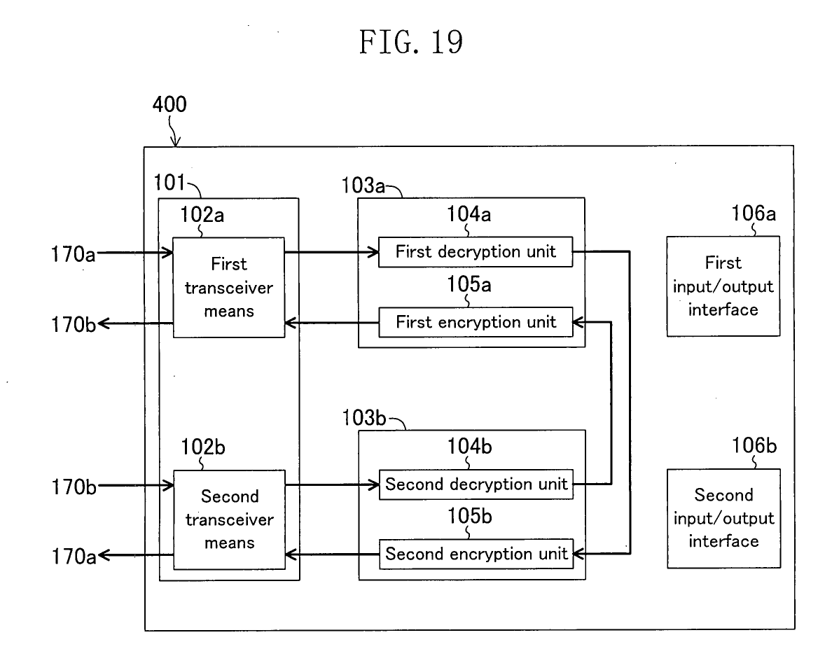

FIG. 19 is a block diagram showing a configuration of a data transceiver of the fourth embodiment. FIG. 19 also shows data transmission paths in a third transmission mode and a third reception mode. In FIG. 19, the same members as those of the data transceiver 100 of the first embodiment shown in FIG. 1 are identified by the same reference numerals.

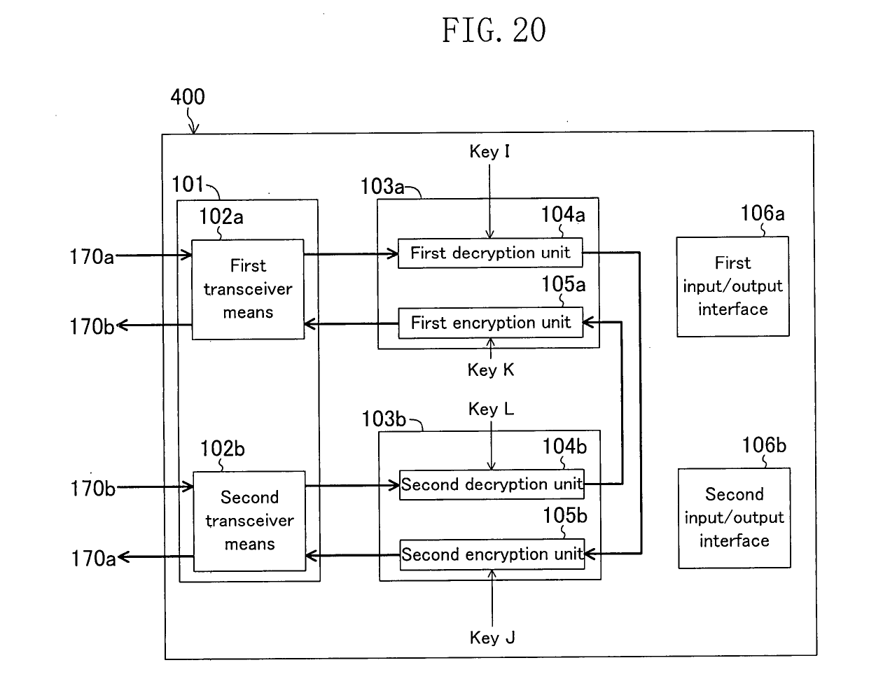

FIG. 20 is a diagram showing keys for use in encrypting or decrypting third transmission data or third received data in a third transmission mode and a third reception mode shown in FIG. 19.

Hereinafter, the data transmission paths in the third transmission mode and the third reception mode will be described.

As shown in FIG. 19, in the third transmission mode (a data transmission path 170a), third transmission data received by a first transmitting/receiving means 102a is decrypted by a first decryption unit 104a in a first encrypting/decrypting means 103a. Then, the decrypted third transmission data is reencrypted by a second encryption unit 105b in a second encrypting/decrypting means 103b. Thereafter, the reencrypted third transmission data is transmitted from a second transceiver means 102b.

On the other hand, in the third reception mode (a data transmission path 170b), third received data received by the second transmitting/receiving means 102b is decrypted by the second decryption unit 104b in the second encrypting/decrypting means 103b. Then, the decrypted third received data is reencrypted by the first encryption unit 105a in the first encrypting/decrypting means 103a. Thereafter, the reencrypted third received data is transmitted from the first transceiver means 102a.

As shown in FIG. 20, with respect to keys for use in encrypting or decrypting the third transmission data and the third received data, in the third transmission mode, the third transmission data is decrypted by the first decryption unit 104a using a fifth decryption key Key I, and then is reencrypted by the second encryption unit 105b using a sixth encryption key Key J. On the other hand, in the third reception mode, the third received data is decrypted by the second decryption unit 104b using a sixth decryption key Key L, and then is reencrypted by the first encryption unit 105a using a fifth encryption key Key K.

As described above, in the fourth embodiment, the third transmission data or the third received data received from a network connected to a transceiver means 101 is reencrypted to be transmitted back to the network in both the third transmission mode and the third reception mode. Accordingly, even if an external device which does not have the function of changing an encrypting means on the network, for example, is used, data from this external device is reencrypted via a data transceiver 400 according to this embodiment. That is, the data transceiver 400 serves as a reencrypting device for reencrypting data. This ensures robustness of copyright protection of data on a network connected to an external device.

In the third transmission mode and the third reception mode in the fourth embodiment, third transmission data or third received data which has been encrypted once is reencrypted. Alternatively, third transmission data or third received data which has never been encrypted may be encrypted to be transmitted. Then, even if an external device which does not have the function of encryption is used, for example, data stored on this external device is encrypted via the data transceiver 400 of this embodiment. That is, the data transceiver 400 serves as an encrypting device for encrypting data. This ensures robustness of copyright protection of data on a network connected to an external device.

The data transceiver of the fourth embodiment may be configured to perform transmission and reception in a manner similar to the first transmission mode, the first reception mode, the second transmission mode and the second reception mode in the first embodiment.

In the third transmission mode and the third reception mode in the fourth embodiment, transceiver means for reception (102a or 102b) and transceiver means for transmission (102a or 102b) are separately provided. Alternatively, the same transceiver means (102a or 102b) may perform both transmission and reception.

(Modified Example 1 of Embodiment 4)

Hereinafter, a data transceiver according to a first modified example of the fourth embodiment will be described with reference to the drawings.

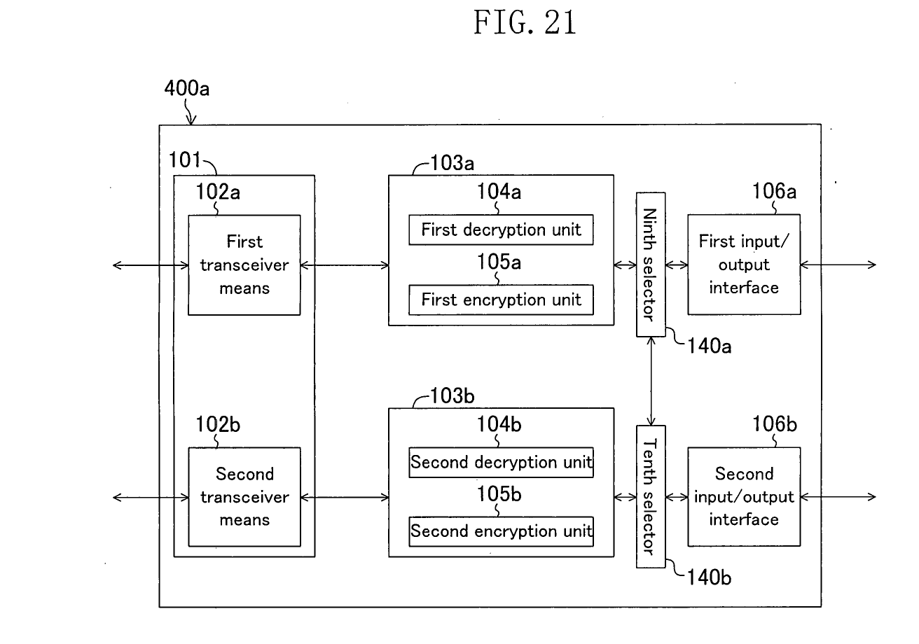

FIG. 21 is a block diagram showing a configuration of the data transceiver of the first modified example of the fourth embodiment. In FIG. 21, the same members as those of the data transceiver 400 of the fourth embodiment shown in FIG. 19 are identified by the same reference numerals.

As shown in FIG. 21, a data transceiver 400a according to the first modified example of the fourth embodiment is characterized by including ninth and tenth selectors 140a and 140b for switching between data transmission paths in addition to the configuration of the data transceiver 400 of the fourth embodiment shown in FIG. 19. Specifically, the ninth selector 140a is provided on a data transmission path between the first encrypting/decrypting means 103a and the first input/output interface 106a. The tenth selector 140b is provided on a data transmission path between the second encrypting/decrypting means 103b and the second input/output interface 106b. In this manner, the third transmission mode and the third reception mode described in the fourth embodiment are implemented.

In the third transmission mode, third transmission data received by the first transceiver means 102a passes through the first encrypting/decrypting means 103a, the ninth selector 140a, the tenth selector 140b and the second encrypting/decrypting means 103b in this order, and then is transmitted from the second transceiver means 102b. On the other hand, in the third reception mode, third received data received by the second transceiver means 102b passes through the second encrypting/decrypting means 103b, the tenth selector 140b, the ninth selector 140a and the first encrypting/decrypting means 103a in this order, and then is transmitted from the first transceiver means 102a.

In this manner, in the first modified example of the fourth embodiment, the ninth and tenth selectors 140a and 140b performs switching between the data transmission paths to implement the third transmission mode and the third reception mode. This ensures advantages obtained in the fourth embodiment.

In the first modified example of the fourth embodiment, a selector controlling section for controlling the ninth and tenth selectors 140a and 140b is preferably provided.

In the first modified example of the fourth embodiment, to perform switching between data transmission paths, the ninth and tenth selectors 140a and 140b may be replaced with other switching means for switching between data transmission paths.

(Modified Example 2 of Embodiment 4)

Hereinafter, a data transceiver according to a second modified example of the fourth embodiment will be described with reference to the drawings.

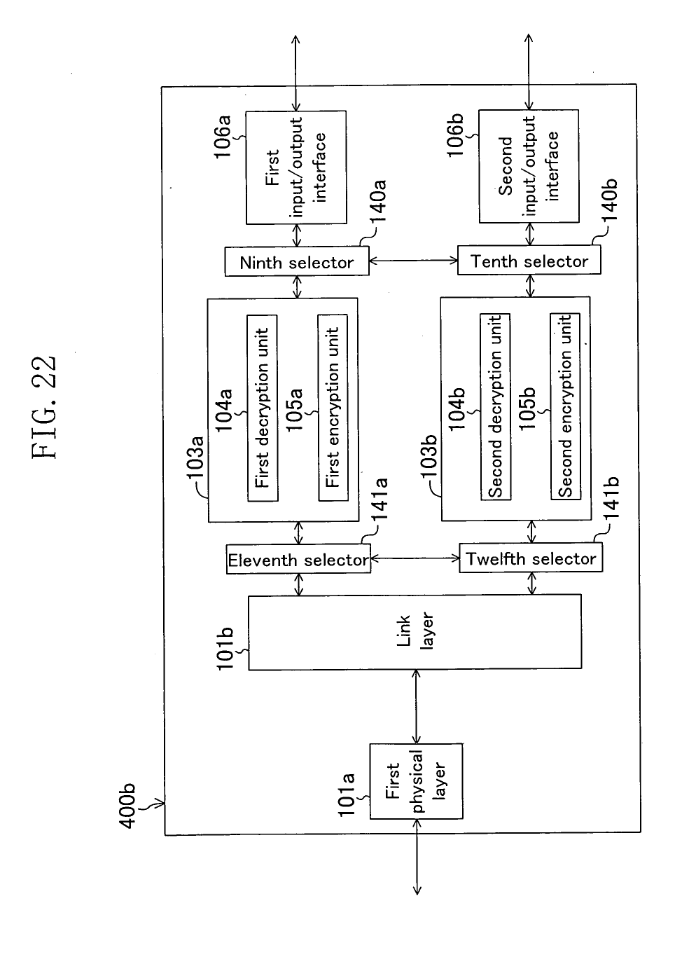

FIG. 22 is a block diagram showing a configuration of the data transceiver of the second modified example of the fourth embodiment. In FIG. 22, the same members as those of the data transceiver 100a of the modified example of the first embodiment shown in FIG. 6 or the data transceiver 400a of the first modified example of the fourth embodiment are identified by the same reference numerals.

As shown in FIG. 22, a data transceiver 400b according to the second modified example of the fourth embodiment is characterized in that the transceiver means 101 of the data transceiver 400a of the first modified example of the fourth embodiment shown in FIG. 21 is constituted by a first physical layer 101a and a link layer 101b conforming to the IEEE 1394 standard and that eleventh and twelfth selectors 141a and 141b are further provided.

In the second modified example of the fourth embodiment, the first physical layer 101a and the link layer 101b conforming to the IEEE 1394 standard are provided, so that transmission and reception are performed in compliance with the IEEE 1394 standard. In addition, the ninth and tenth selectors 140a and 140b ensure the advantages obtained by the first modified example of the fourth embodiment even in the case of transmitting and receiving data to/from an external device on an IEEE 1394 network.

In the second modified example of the fourth embodiment, the eleventh and twelfth selectors 141a and 141b are further provided in addition to the ninth and tenth selectors 140a and 140b. Accordingly, in a case where the data transceiver 400b of this modified example is applied to a PC (personal computer), if data stored on a hard disk in the PC passes through the first input/output interface 106a, the ninth selector 140a, the first encrypting/decrypting means 103a, the eleventh selector 141a, the twelfth selector 141b, the second encrypting/decrypting means 103b, the tenth selector 140b and the second input/output interface 106b in this order, data is reencrypted and is stored again.

Embodiment 5

Hereinafter, a data transceiver system according to a fifth embodiment of the present invention will be described with reference to the drawings.

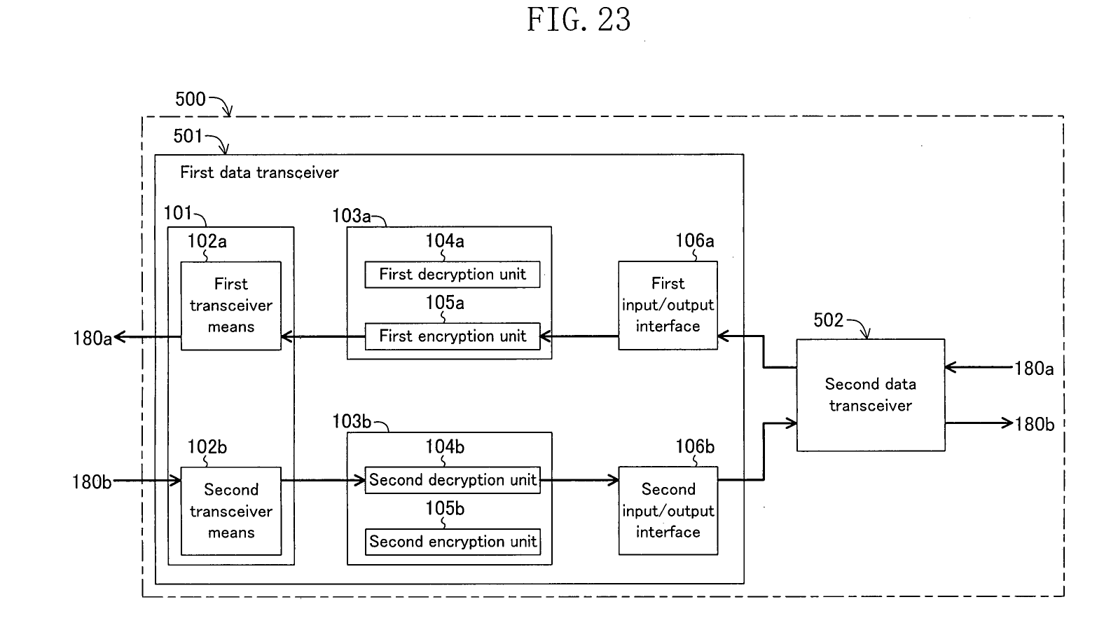

FIG. 23 is a block diagram showing a configuration of the data transceiver system of the fifth embodiment. In FIG. 23, the same members as those of the data transceiver 100 of the first embodiment shown in FIG. 1 are identified by the same reference numerals.

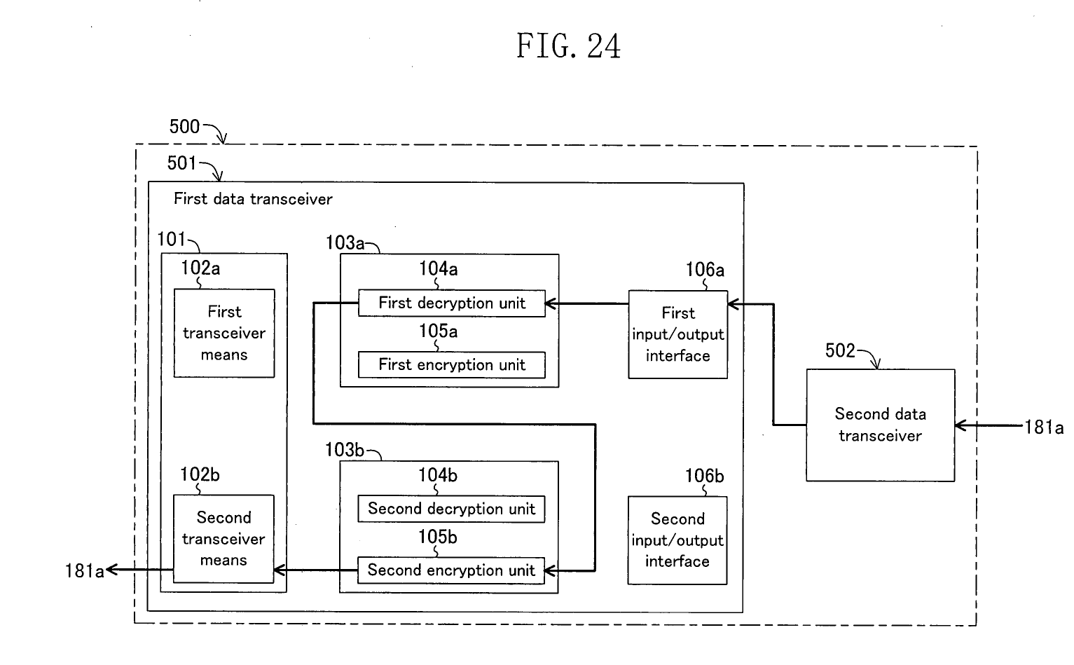

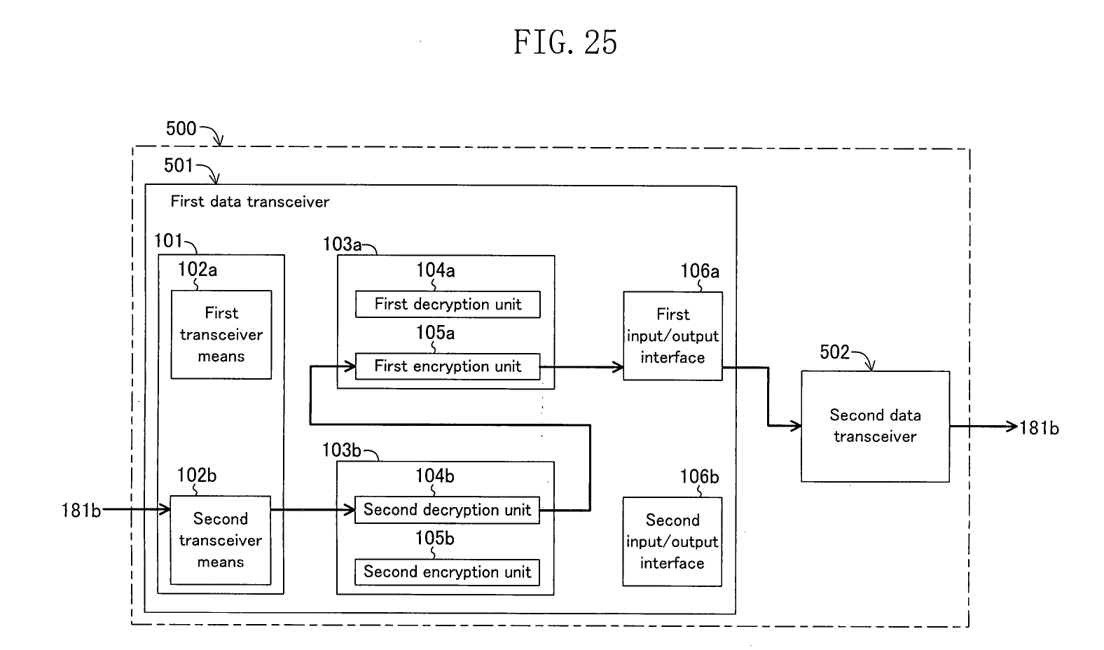

FIG. 23 shows data transmission paths in a first transmission mode and a first reception mode in the fifth embodiment. FIG. 24 shows a data transmission path in a second transmission mode in the fifth embodiment. FIG. 25 shows a data transmission path in a second reception mode in the fifth embodiment.

As shown in FIG. 23, a data transceiver system 500 according to the fifth embodiment includes: a first data transceiver 501 (which is identical with the data transceiver 100 of the first embodiment shown in FIG. 1) for transmitting input data (transmission data) and outputting received data (received data); and a second data transceiver 502 for receiving input data and outputting received data. The specific configuration of the first data transceiver 501 is the same as that of the data transceiver 100 shown in FIG. 1, and thus description thereof will be herein omitted.

Hereinafter, data transmission paths in a case where transmissions in first and second transmission modes and reception in first and second reception modes are performed in this embodiment will be described.

As shown in FIG. 23, in the first transmission mode (a data transmission path 180a), data (first transmission data) received by the second transceiver 502 is output to the first data transceiver 501. Thereafter, the first transmission data which has been input via a first input/output interface 106a is encrypted by a first encryption unit 105a in a first encrypting/decrypting means 103a. Then, the encrypted first transmission data is transmitted from a first transceiver means 102a. On the other hand, in the first reception mode (a data transmission path 180b), first received data received by a second transceiver means 102b is decrypted by a second decryption unit 104b in a second encrypting/decrypting means 103b. Thereafter, the decrypted first received data is output from a second input/output interface 106b to the second data transceiver 502. Then, the first received data input to the second data transceiver 502 is transmitted from the second data transceiver 502.

As shown in FIG. 24, in the second transmission mode (a data transmission path 181a), data (second transmission data) received by the second transceiver 502 is output to the first data transceiver 501. Then, the second transmission data which has been input via a first input/output interface 106a is decrypted by a first decryption unit 104a in the first encrypting/decrypting means 103a. Subsequently, the decrypted second transmission data is reencrypted by a second encryption unit 105b in the second encrypting/decrypting means 103b. Thereafter, the reencrypted second transmission data is transmitted from the second transceiver means 102b.

On the other hand, as shown in FIG. 25, in the second reception mode (a data transmission path 181b), second received data received by the second transceiver means 102b is decrypted by the second decryption unit 104b in the second encrypting/decrypting means 103b. Thereafter, the decrypted second received data is reencrypted by the first encryption unit 105a in the encrypting/decrypting means 103a. Subsequently, the reencrypted second received data is output from the first input/output interface 106a to the second data transceiver 502. Then, the second received data input to the second data transceiver 502 is transmitted from the second data transceiver 502.

As described above, in the fifth embodiment, in the first transmission mode, the first transmission output from the second data transceiver 502 to the first data transceiver 501 is encrypted in the first data transceiver 501 to be transmitted. On the other hand, in the first reception mode, the encrypted first received data is decrypted in the first data transceiver 501, and then output to the second data transceiver 502. That is, data which is not encrypted is input and output between the first data transceiver 501 and the second data transceiver 502. Accordingly, transmission and reception suitable for the case of inputting and outputting data which does not need copyright protection or non-confidential is performed.

In the fifth embodiment, in the second transmission mode, the encrypted second transmission data is output to the first data transceiver 501 and then decrypted in the first data transceiver 501. On the other hand, in the second reception mode, the second received data reencrypted in the first data transceiver 501 is output to the second data transceiver 502. Accordingly, data to be input/output between the first data transceiver 501 and the second data transceiver 502 is always kept encrypted. This prevents illegal copying or intercepting of data which is input and output between the first and second data transceiver 501 and 502. As a result, robustness of copyright protection of data on a network connected to the first and second data transceivers 501 and 502 is ensured.

In the second transmission mode in the fifth embodiment, the second transmission data is decrypted by the first decryption unit 104a, and then reencrypted by the second encryption unit 105b. Alternatively, the second transmission data may be decrypted by the second decryption unit 104b and then reencrypted by the first encryption unit 105a. In the second reception mode, the second received data is decrypted by the second decryption unit 104b and then reencrypted by the first encryption unit 105a. Alternatively, the second received data may be decrypted by the first decryption unit 104a and then encrypted by the second encryption unit 105b.

In the case of transmission in the second transmission mode in the fifth embodiment, the second transmission data is preferably reencrypted by the second encryption unit 105b using a key different from an encryption key used for encrypting the second transmission data. In the case of reception in the second reception mode, the second received data is preferably reencrypted by the first encryption unit 105a using a key different from an encryption key used for encrypting the second received data. In such a case, the first data transceiver 501 more preferably includes a key setting controlling section for setting the keys for encryption or decryption performed in the first and second encrypting/decrypting means 103a and 103b.

In the fifth embodiment, selectors for switching between data transmission paths are preferably provided on a data transmission path between the first transceiver means 102a and the first encrypting/decrypting means 103a and a data transmission path between the second transceiver means 102b and the second encrypting/decrypting means 103b, respectively. In such a case, a selector controlling section for controlling selectors is more preferably provided.

The first data transceiver 501 of the fifth embodiment is preferably integrated on a single integrated circuit.

The first data transceiver 501 of the fifth embodiment is furnished with transceiver means, encrypting/decrypting means and input/output interfaces, in two sets that respectively include one of each of the components. The data transceiver 504 may, however, be furnished with three or more of the sets.

(Modified Example of Embodiment 5)

Hereinafter, a data transceiver system according to a modified example of the fifth embodiment will be described with reference to the drawings.

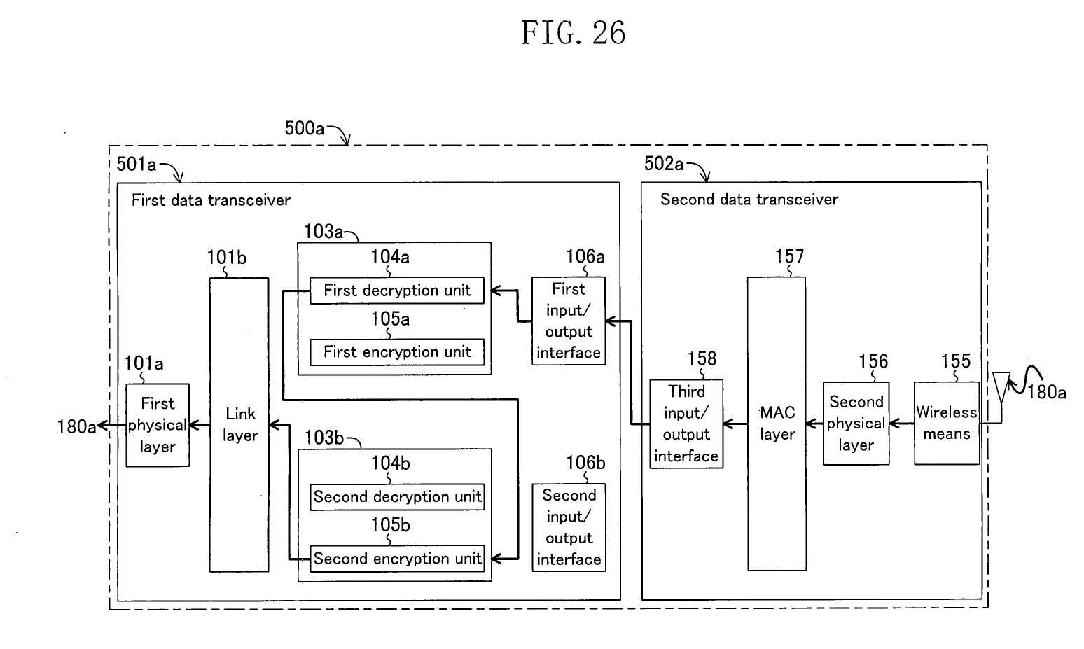

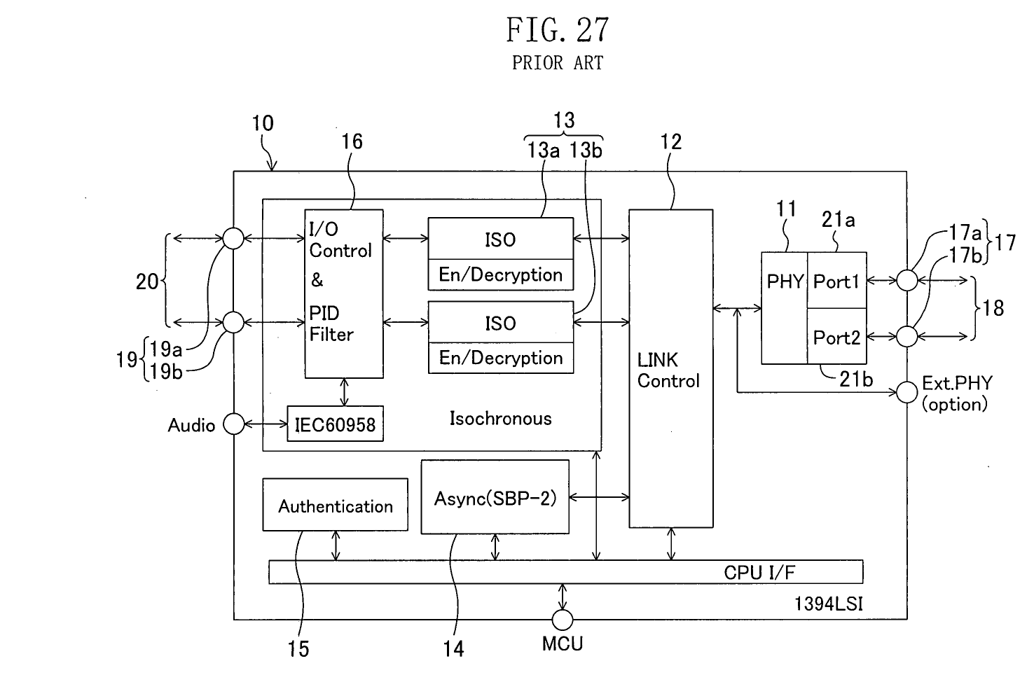

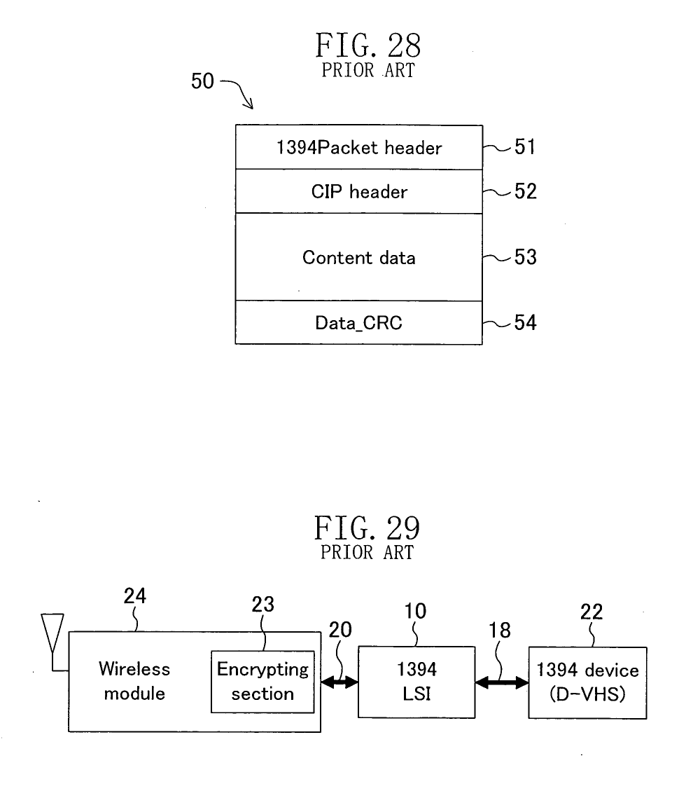

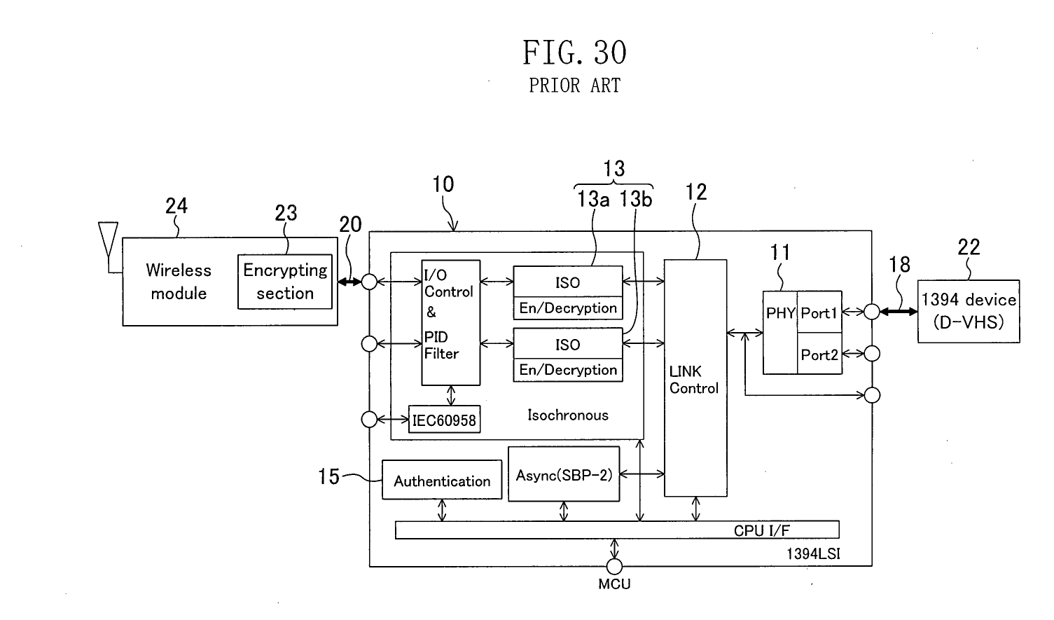

FIG. 26 is a block diagram showing a configuration of the data transceiver system of the modified example of the fifth embodiment. As an example, a data transmission path 180a for use in a second transmission mode is also shown. In FIG. 26, the same members as those of the data transceiver system 500 of the fifth embodiment shown in FIG. 23 are identified by the same reference numerals.

As shown in FIG. 26, a data transceiver system 500a according to the modified example of the fifth embodiment is characterized in that the first data transceiver 501 of the fifth embodiment shown in FIG. 23 performs transmission and reception in compliance with the IEEE 1394 standard and that the second data transceiver 502 performs wireless transmission and reception in compliance with the IEEE 802.11 standard.

Specifically, a first data transceiver 501a according to this modified example includes a transceiver means constituted by a first physical layer 101a and a link layer 101b conforming to the IEEE 1394 standard. On the other hand, a second data transceiver 502a according to this modified example includes: a third input/output interface 158; a wireless means 155 conforming to the IEEE 802.11 standard; a second physical layer 156; and a MAC (media access control) layer 157.

Accordingly, in the modified example of the fifth embodiment, the first data transceiver 501a performs transmission and reception in compliance with the IEEE 1394 standard, so that copyright of data on an IEEE 1394 network protected in compliance with the IEEE 1394 standard is also protected when being exchanged between the first data transceiver 501a and the second data transceiver 502a. That is, robustness of copyright protection of data on the IEEE 1394 network is ensured.

In the modified example of the fifth embodiment, the second data transceiver 502a performs transmission and reception in compliance with the IEEE 802.11 standard, so that copyright of data on an IEEE 802.11 network protected in compliance with the IEEE 802.11 standard is also protected when being exchanged between the first data transceiver 501a and the second data transceiver 502a. That is, robustness of copyright protection of data on the IEEE 802.11 network is ensured.

Accordingly, in the fifth embodiment, even in the case of transmitting data between the IEEE 1394 network and the IEEE 802.11 network, robustness of copyright protection of data on both of the networks is ensured. Therefore, even if data received in compliance with the IEEE 1394 standard is transmitted in a wireless manner in compliance with IEEE 802.11, copyright of the data is protected.

In the modified example of the fifth embodiment, decryption of the second transmission data by the first encrypting/decrypting means 103a in the second transmission mode and encryption of the second received data by the first encrypting/decrypting means 103a in the second reception mode are preferably in compliance with the IEEE 802.11 standard.

Then, the second data transceiver 502a performs encryption and decryption in compliance with the IEEE 802.11 standard, thus ensuring protection of copyright of data on the IEEE 802.11 network.

1. A data transceiver comprising:
at least first and second encrypting/decrypting means each for encrypting and decrypting data; and
transceiver means for transmitting and receiving data,
wherein first transmission data encrypted by the first or second encrypting/decrypting means is transmitted by the transceiver means in a first transmission mode,
first received data received by the transceiver means is decrypted by the first or second encrypting/decrypting means in a first reception mode,
second transmission data decrypted by the first encrypting/decrypting means is encrypted by the second encrypting/decrypting means and then is transmitted by the transceiver means, in a second transmission mode, and
second received data received by the transceiver means is decrypted by the second encrypting/decrypting means and then is encrypted by the first encrypting/decrypting means, in a second reception mode.

2. The data transceiver of claim 1, wherein in the second transmission mode, the second transmission data is decrypted by the first encrypting/decrypting means using a first key and then is encrypted by the second encrypting/decrypting means using a second key.

3. The data transceiver of claim 1, wherein in the second reception mode, the second received data is decrypted by the second encrypting/decrypting means using a third key and then is encrypted by the first encrypting/decrypting means using a fourth key.

4. The data transceiver of claim 1, further comprising switching means for switching between a data transmission path for use in the first transmission mode and a data transmission path for use in the second transmission mode or between a data transmission path for use in the first reception mode and a data transmission path for use in the second reception mode.

5. The data transceiver of claim 4, wherein
the switching means includes:
a first selector provided on a data transmission path between the first encrypting/decrypting means and the transceiver means; and
a second selector provided on a data transmission path for data which has passed through a data transmission path between the second encrypting/decrypting means and the transceiver means to be output from the second encrypting/decrypting means,
a data transmission path along which the second transmission data passes through the first encrypting/decrypting means, the first selector, the second selector, the second encrypting/decrypting means and the transceiver means in this order is selected in the second transmission mode, and
a data transmission path along which the second received data passes through the transceiver means, the second encrypting/decrypting means, the second selector, the first selector and the first encrypting/decrypting means in this order is selected in the second reception mode.

6. The data transceiver of claim 4, wherein
the switching means includes:
a first switch provided on a data transmission path between the first encrypting/decrypting means and the transceiver means;
a second switch provided on a data transmission path for data which has passed through a data transmission path between the second encrypting/decrypting means and the transceiver means to be output from the second encrypting/decrypting means; and
a third switch provided on a data transmission path connecting the data transmission path between the first encrypting/decrypting means and the first switch and the data transmission path between the second encrypting/decrypting means and the second switch to each other, and
the first through third switches are turned ON or OFF in combination in such a manner that
a data transmission path along which the second transmission data passes through the first encrypting/decrypting means, the third switch, the second encrypting/decrypting means and the transceiver means in this order is selected in the second transmission mode and
a data transmission path along which the second received data passes through the transceiver means, the second encrypting/decrypting means, the third switch and the first encrypting/decrypting means in this order is selected in the second reception mode.

7. A data transceiver comprising:
at least first and second encrypting/decrypting means each for encrypting and decrypting data; and
transceiver means for transmitting and receiving data,
wherein first transmission data encrypted by the first or second encrypting/decrypting means is transmitted by the transceiver means in a first transmission mode,
first received data received by the transceiver means is decrypted by the first or second encrypting/decrypting means in a first reception mode, and
second transmission data received by the transceiver means is decrypted by the first encrypting/decrypting means, is encrypted by the second encrypting/decrypting means and then is transmitted by the transceiver means, in a second transmission mode.

8. The data transceiver means of claim 7, wherein in the second transmission mode, the second transmission data is decrypted by the first encrypting/decrypting means using a fifth key and then is encrypted by the second encrypting/decrypting means using a sixth key.

9. The data transceiver of claim 7, further comprising:
a first selector provided on a data transmission path for data which has passed through a data transmission path between the first encrypting/decrypting means and the transceiver means to be output from the first encrypting/decrypting means; and
a second selector provided on a data transmission path for data which has passed through the data transmission path between the first encrypting/decrypting means and the transceiver means to be output from the second encrypting/decrypting means,
wherein in the second transmission mode, a data transmission path along which the second transmission data passes through the transceiver means, the first encrypting/decrypting means, the first selector, the second selector, the second encrypting/decrypting means and the transceiver means in this order is selected.

10. The data transceiver of claim 2, further comprising a key setting controlling section for selecting the type of a key for use in encryption or decryption performed by each of the first and second encrypting/decrypting means and for determining whether or not the key is set in each of the first and second encrypting/decrypting means.

11. The data transceiver of claim 5, further comprising a selector controlling section for determining the selections of the data transmission paths performed by the first and second selectors.

12. The data transceiver of claim 11, wherein the selector controlling section includes a register in which information for determining operation of the first and second selectors is written.

13. The data transceiver of claim 6, further comprising a switch controlling section for determining the switching between the data transmission paths performed by each of the first through third switches.

14. The data transceiver of claim 13, wherein the switch controlling section includes a register in which information for determining operation of the first through third switches is written.

15. The data transceiver of claim 1, wherein the transceiver means includes at least first and second transceiver means, and
transmission of the first transmission data by the first transceiver means in the first transmission mode and reception of the first received data by the second transceiver means in the first reception mode are performed at the same time.

16. A data transceiver comprising:
at least first and second encrypting/decrypting means each for encrypting and decrypting data;
transceiver means for transmitting and receiving data;
an input/output interface for input and output of data to/from an external device;
first switching means provided on a data transmission path between the transceiver means and the first encrypting/decrypting means; and
second switching means provided on a data transmission path between the input/output interface and the second encrypting/decrypting means,
wherein the first switching means operates in such a manner as to connect the data transmission path between the first switching means and the first encrypting/decrypting means to a data transmission path between the first switching means and the transceiver means or to a data transmission path between the first switching means and the second switching means, and
the second switching means operates in such a manner as to connect the data transmission path between the second switching means and the second encrypting/decrypting means to the data transmission path between the second switching means and the input/output interface or to the data transmission path between the second switching means and the first switching means.

17. A data transceiver comprising:
at least first and second encrypting/decrypting means each for encrypting and decrypting data;
transceiver means for transmitting and receiving data;
an input/output interface for input and output of data to/from an external device;
first switching means provided on a data transmission path between the input/output interface and the first encrypting/decrypting means; and
second switching means provided on a data transmission path between the input/output interface and the second encrypting/decrypting means,
wherein the first switching means operates in such a manner as to connect the data transmission path between the first switching means and the first encrypting/decrypting means to the data transmission path between the first switching means and the input/output interface or to a data transmission path between the first switching means and the second switching means, and
the second switching means operates in such a manner as to connect the transmission path between the second switching means and the second encrypting/decrypting means to the data transmission path between the second switching means and the input/output interface or to the data transmission path between the second switching means and the first switching means.

18. The data transceiver of claim 1, wherein all said means are integrated on a single integrated circuit.

19. The data transceiver of claim 1, wherein the transceiver means performs transmission and reception in compliance with the IEEE 1394 standard.

20. A data transceiver system comprising:
a first data transceiver including at least first and second encrypting/decrypting means each for encrypting and decrypting data and transceiver means for transmitting and receiving data; and
a second data transceiver for transmitting and receiving data,
wherein first transmission data received by the second data transceiver is output to the first data transceiver, is decrypted by the first or second encrypting/decrypting means and then is transmitted by the transceiver means, in a first transmission mode,
first received data received by the transceiver means is decrypted by the first or second encrypting/decrypting means, is output to the second data transceiver and then is transmitted by the second data transceiver, in a first reception mode,
second transmission data received by the second data transceiver is output to the first data transceiver, is decrypted by the first encrypting/decrypting means, is encrypted by the second encrypting/decrypting means and then is transmitted by the transceiver means, in a second transmission mode, and
second received data received by the transceiver means is decrypted by the second encrypting/decrypting means, is encrypted by the first encrypting/decrypting means, is output to the second data transceiver, and then is transmitted by the second data transceiver, in a second reception mode.

21. The data transceiver system of claim 20, wherein the first data transceiver further includes switching means for switching between a data transmission path for use in the first transmission mode and a data transmission path for use in the second transmission mode or between a data transmission path for use in the first reception mode and a data transmission path for use in the second reception mode.

22. The data transceiver system of claim 20, wherein in the second transmission mode, the second transmission data is decrypted by the first encrypting/decrypting means using a seventh key and then is encrypted by the second encrypting/decrypting means using an eighth key.

23. The data transceiver system of claim 20, wherein in the second reception mode, the second received data is decrypted by the second encrypting/decrypting means using a ninth key and then is encrypted by the first encrypting/decrypting means using a tenth key.

24. The data transceiver system of claim 20, wherein the transceiver means performs transmission and reception in compliance with the IEEE 1394 standard.

25. The data transceiver system of claim 20, wherein the second data transceiver performs transmission and reception in compliance with the IEEE 802.11 standard.

26. The data transceiver system of claim 20, wherein decryption of the second transmission data in the second transmission mode and encryption of the second received data in the second reception mode are performed in compliance with the IEEE 802.11 standard.
